(19) United States
(12) Patent Application Publication
(10) Pub. No.: US 2023/0220206 A1
(43) Pub. Date: Jul. 13, 2023

(54) REJUVENATING AGENTS FOR ASPHALT RECYCLING

(71) Applicant: BASF SE, Ludwigshafen am Rhein (DE)

(72) Inventors: Susanne SCHNEIDER, Trostberg (DE); Karin SCHREINER, Trostberg (DE); Stefanie Silvia FAUST, Trostberg (DE); Kerstin HAFNER, Trostberg (DE); Michael DIETZSCH, Ludwigshafen am Rhein (DE)

(21) Appl. No.: 18/008,680

(22) PCT Filed: Jun. 8, 2021
(86) PCT No.: PCT/EP2021/065321

§ 371 Date: Dec. 7, 2022

(30) Foreign Application Priority Data
Jun. 9, 2020 (EP) 20178931.0

(51) Int. Cl. C08L 95/00; C08K 5/06; C08K 5/20

(52) U.S. Cl. CPC C08L 95/00; C08K 5/06; C08K 5/20; C08L 2555/10; C08L 2555/34; C08L 2555/40

(57) ABSTRACT

The present invention relates to a binder composition comprising a bituminous binder and at least one rejuvenating agent. The present invention further relates to a method for evaluating the efficiency of a rejuvenating agent in a binder composition.

The present invention relates to a binder composition comprising a bituminous binder and at least one rejuvenating agent. Further, the present invention relates to asphalt compositions comprising the binder composition according to the present invention. The present invention further relates to a method for evaluating the efficiency of a rejuvenating agent in a binder composition.

Reclaimed asphalt binders from road pavements as well as from other sources (e.g. reclaimed asphalt pavement, RAP or asphalt shingles from roofing, RAS) are important as well as valuable waste materials and are increasingly reused in asphalt manufacturing. According to the “European Asphalt Pavement Association” (EAPA, Asphalt in FIGS. 2018) ˜50 million tons of reclaimed asphalt have been reused in Europe in 2018—out of in total 298 million tons asphalt produced in 2018 this represents ˜17% of asphalt produced with reclaimed asphalt. The amount of reclaimed asphalt reused in manufacturing asphalt will further increase in the upcoming years, probably towards 50% in 2035 in Europe. The situation in other regions of the world is similar, forming a global trend and making asphalt to one of the most important materials for recycling in the world.

However, asphalt in road paving or any other application, shows deterioration with time, resulting in higher viscosities at high temperatures and increased brittleness therefore higher tendency to crack, in particular at lower temperatures. These ageing effects are attributed to the binder phase of the asphalt, the bitumen. In order to reuse reclaimed asphalt without any compromises on the asphalt performance, the bitumen property profile needs to be brought back as close as possible to the profile of virgin bitumen. This so-called rejuvenation of the aged bitumen in reclaimed asphalt is performed with chemicals, so-called rejuvenating agents, which are added to the asphalt manufacturing process in an appropriate manner. Even though plenty of such rejuvenating agents have already been described in the literature and some of them are also commercially available, they are still rarely used. Main concerns expressed on this aspect by the asphalt manufacturers are a supposed lack of performance in general and especially uncertainties regarding their long-term performance especially in high value applications as e.g. surface layers, as well as safety concerns as many of the existing benchmarks are aromatic oils, known for their safety hazards such as their toxicological profiles.

Rejuvenating agents can be classified following their chemical structure and composition:
Replenishing the bitumen phase by adding soft bitumen (e.g. KONINK BAM GROEP NV, WO2014168478; or RECYCLED ASPHALT SHINGLE TECHNOLOGY LLC, WO2013075088), is still the most often applied method as it allows to adjust the aged bitumen very close to the virgin bitumen profile. However, with an increasing share of reclaimed asphalt re-used, this method fails as the necessary amount of soft bitumen needed exceeds the overall amount of bitumen for the desired asphalt composition to be achieved.
Modification with low viscosity products (mainly aromatics) obtained from crude oil distillation or any other hydrocarbon-based process. These products are also called “flux oils” and their utilization in asphalt manufacturing is also very well established, but with clear disadvantages regarding the restoration of the rheological property profiles, the lack of long-term performance as well as unacceptable safety profiles.
Oils from renewable resources especially plant-based oils (triglycerides) as e.g. soybean oil or rape seed oil with similar behavior and disadvantages as “flux oils” (e.g. M. Freisthler, U.S. Pat. No. 7,008,670).
Modified triglycerides: in order to overcome the described disadvantages of triglycerides, there are several examples to be found in the literature to modify them in an appropriate manner and also to offer them as commercial products (e.g. CARGILL working with oligomerized triglycerides containing unsaturated fatty acids e.g. WO 2018 191501; SASOL claiming the combination of “flux oils” with hydrocarbon waxes e.g. EP 2052056; COLLABORATIVE AGGREGATES combining triglycerides with curing agents as e.g. Salicylic acid e.g. WO 2015 070180)
Aromatic oils from renewable resources as e.g. cashew nutshell liquid (CNSL) (VENTRACO, EP 3208288)
Tall oil fatty acids and esters including rosin esters (as e.g. claimed by ARIZONA CHEM. in WO 2013 163463)
Bio-based oils plus polymers (triglycerides as well as tall oil fatty acid esters) (e.g. KRATON, WO 2017 117127)
Plant-based oligoterpenes and sterols (e.g. claimed by ARIZONA CHEM. in WO 2016 102314 and ERGON in WO 2018 031540)
Reactive rejuvenating agents (e.g. claimed by University of Huelva in ES 22375125)
(Non-ionic) or (cationic) surfactants (e.g. claimed by CECA in WO 2013 053882)

All products or product mixtures described in the literature show (more or less) positive effects on the bitumen property profiles and/or on the asphalt performance, but the performance profiles of all these products are only partly described, always using different test procedures, not allowing to fully evaluate their rejuvenation potential by following the published information and are finally not fully convincing.

Chemical substances derived preferably from renewable resources led to some commercially available products, which allow to rejuvenate reused asphalt reasonably well for some candidates, but with negative impact on the rejuvenated binder for many of them. The industry needs a more flexible concept allowing to process even higher amounts of reclaimed asphalt and the reuse of asphalt even in surface layers. Further, acceptable safety profiles are needed and performance oriented rejuvenating agents that have an actual impact on the microstructure of the bitumen (e.g. the asphaltene micelles) and do not simply dilute, as well as easily applicable test methods, e.g. allowing to easily adapt the rejuvenating substances to the actual profile of the available binder from reclaimed asphalt.

To summarize, there is the ongoing need for an integrative concept for higher utilization rates of reclaimed asphalt especially in surface layers. This concept includes:
rejuvenating agents allowing to almost completely or completely restore the property profiles of the bitumen phase including showing an acceptable ageing behavior,
analytical test procedures, which allow to adapt the application of rejuvenating agents to the specific reclaimed asphalt and the desired use of the asphalt to be manufactured,
acceptable safety profiles, and
functional rejuvenation, based on tailor-made synthetic solutions.

Against this background, it was an object of the present invention to provide flexible product solutions allowing to process any kind of reused asphalt with as few limitations as possible. In this connection it was an object to provide a binder composition comprising a rejuvenating agent. In particular, it was an object to provide a binder composition, wherein the rejuvenating agents allow to almost completely or completely restore the property profiles of the bitumen phase including showing an acceptable ageing behavior. It has been a particular object to provide a binder composition having well balanced properties in view of softness, viscosity, and elasticity. In this connection it was an object to provide a binder composition comprising a particularly high amount of reclaimed asphalt and/or enabling its reuse in asphalt layers which demand high performance such as e.g. the top layer. In particular, it was an object to provide a binder composition having acceptable safety profiles. Further, it was an object to provide an asphalt composition comprising a high amount of reclaimed asphalt. Further, it was an object to provide analytical test procedures allowing to adapt the application of rejuvenating agents to the specific reclaimed asphalt and the desired use of the asphalt to be manufactured.

It has surprisingly been found that at least one of these objects can be achieved by the binder composition as claimed. It has been found that the binder composition as defined hereinafter provides improved rejuvenating properties. It has further been found that the methods for evaluating the efficiency of a rejuvenating agent as claimed are suitable for determining the bituminous microstructure, by which the advantage of the here claimed rejuvenating agents over the state of the art is clearly distinguishable.

In a first aspect, the present invention therefore relates to a binder composition comprising

(a) a bituminous binder; and

(b) a rejuvenating agent from 0.05 to 20 wt.-%, based on the total amount of the binder composition,

wherein the rejuvenating agent comprises at least an asphaltene dispersant, which is selected from the group consisting of alkoxylates, N,N-dialkylamides of aliphatic carboxylic acids, N-alkyl lactames, and poly(alkylamines), an asphaltene reactivator, which is selected from the group consisting of mono glycidylether and -ester, di- and tri glycidylether, diglycidylether of polymeric alcohol, and mixtures thereof with catalysts, a maltene reactivator, which is a plasticizer, or mixtures thereof.

In the following, preferred embodiments of the components of the binder composition are described in further detail. It is to be understood that each preferred embodiment is relevant on its own as well as in combination with other preferred embodiments.

In a preferred embodiment A1 of the first aspect, the rejuvenating agent introduces a microstructural change of the bitumen micellar structure, preferably wherein the loss tangent of the binder composition is increased compared to the loss tangent of the bituminous binder and/or wherein the amount of the mobile components of the binder composition and/or their respective mobility as per TD NMR is increased compared to the amount of the mobile components of the bituminous binder and/or their respective mobility.

In a preferred embodiment A2 of the first aspect, the rejuvenating agent comprises

(i) the asphaltene dispersant from 1 to 100 wt. %, based on the total amount of the rejuvenating agent;

(ii) the asphaltene reactivator from 1 to 100 wt. %, based on the total amount of the rejuvenating agent;

(iii) the maltene reactivator from 1 to 100 wt. %, based on the total amount of the rejuvenating agent; or

(iv) a mixture consisting of at least two of the components from (i) to (iii) from 1 to 100 wt. %, based on the total amount of the rejuvenating agent.

In a preferred embodiment A3 of the first aspect, the bituminous binder comprises reclaimed asphalt pavement binder, reclaimed asphalt shingle binder, virgin bitumen with a hardness grade of at least 50/70, or a mixture thereof, optionally in combination with a virgin binder.

In a preferred embodiment A4 of the first aspect, the binder composition comprises an asphaltene dispersant, which is selected from the group consisting of alkoxylates having the structure of formula (1)

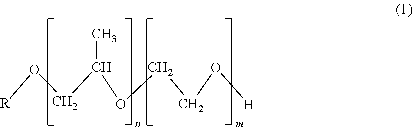

wherein the moieties are as defined hereinafter;

N,N-dialkylamides of aliphatic carboxylic acids having the structure of formula (2)

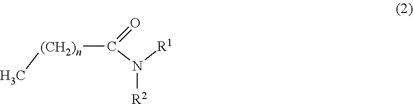

wherein the moieties are as defined hereinafter;

N-alkyl lactames having the structure of formula (3)

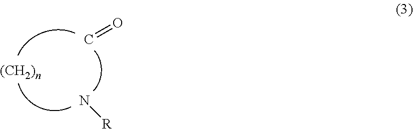

wherein the moieties are as defined hereinafter; or

poly(alkylamines) having the structure of formula (4)

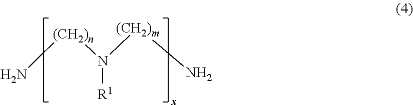

wherein the moieties are as defined hereinafter, wherein these poly(alkylamines) may further be derived at the terminal amine moieties with C₁-C₄-alkyl, fatty acids or alkoxylated;

and/or an asphaltene reactivator, which is selected from the group consisting of mono glycidylether and -ester, di- and tri glycidylether, diglycidylether of polymeric alcohol, and mixtures thereof with catalysts such as N,N-dimethyl benzylamine, wherein the mono glycidylether and -ester, di- and tri glycidylether, diglycidylether of polymeric alcohol have the structure of formula (5a), (5b), (5c), and 5(d)

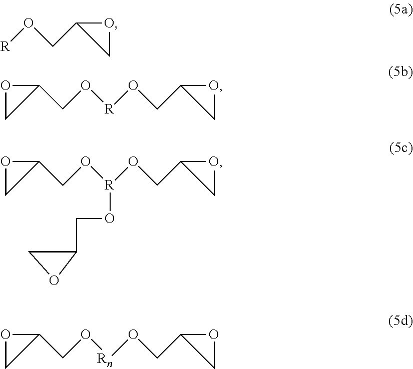

wherein the moieties for formulae (5a) to (5d) are as defined hereinafter;

and/or a maltene reactivator, which is a plasticizer having the formula (7a), (7b), (7c), (7d), or

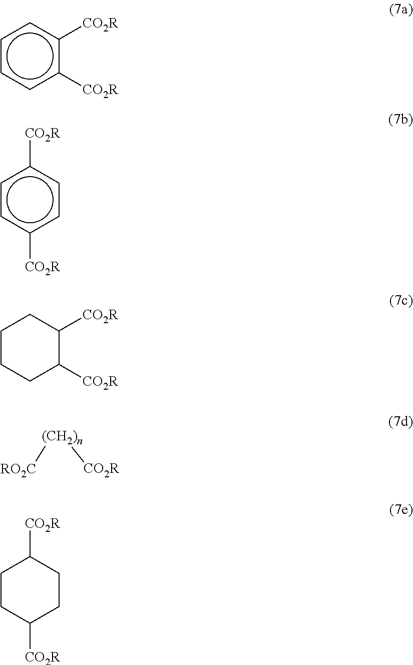

wherein the moieties for formulae (7a) to 7(e) are as defined hereinafter.

In a preferred embodiment A5 of the first aspect, the asphaltene dispersant is present and is selected from the group consisting of alkoxylates having the structure of formula (1)

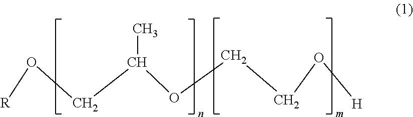

wherein

R is H, C₁-C₂₂-alkyl, C₂-C₂₂-alkenyl, phenyl, or alkyl phenyl, preferably H or C₁-C₂₂-alkyl, more preferably H or C₁-C₁₈-alkyl,

n is 0 to 20, preferably 0 to 15, more preferably 0 to 10,

m is 0 to 20, preferably 0 to 15, more preferably 0 to 10, and wherein n+m≥1, preferably n+m≥5;

in particular wherein the alkoxylates have the structure of formula (1), wherein

R is C₁₀-alkyl or C₁₃-alkyl, preferably 2-propyl heptyl or isotridecyl,

n is 0 to 6,

m is 0 to 8, and wherein

n+m≥5;

N,N-dialkylamides of aliphatic carboxylic acids having the structure of formula (2)

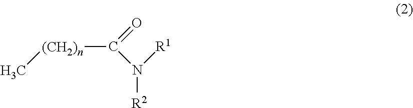

wherein

n is 3 to 16, wherein the carbon atom of at least one “CH₂” moiety may be further substituted with at least one C₁-C₅-alkyl and wherein at least two carbon atoms of two adjacent “CH₂” moieties may form a double bond, preferably 6 to 14, wherein the carbon atom of at least one “CH₂” moiety may be further substituted with at least one C₁-C₅-alkyl,

R¹ is C₁-C₄-alkyl, preferably methyl or ethyl, and

R² is C₁-C₄-alkyl, preferably methyl or ethyl;

in particular wherein the N,N-dialkylamides of aliphatic carboxylic acids have the structure of formula (2), wherein

n is 8 to 12,

R¹ is methyl or ethyl, and

R² is methyl or ethyl;

N-alkyl lactames having the structure of formula (3)

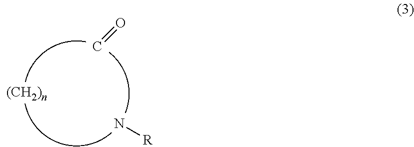

wherein

n is 3 to 11, wherein the carbon atom of at least one “CH₂” moiety may be further substituted with at least one C₁-C₃-alkyl, preferably 3 (pyrrolidone), 5 (caprolactam), or 11 (laurolactam), and

R is C₁-C₂₂-alkyl or C₂-C₂₂-alkenyl, preferably C₄-C₁₈-alkyl;

in particular wherein the N-alkyl lactames have the structure of formula (3), wherein

n is 3 (pyrrolidone), and

R is C₈-C₁₂-alkyl; or

poly(alkylamines) having the structure of formula (4)

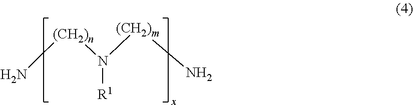

wherein

n is 1 to 6, preferably 2 to 3, wherein at least two carbon atoms of two adjacent “CH₂” moieties may form a double bond,

m is 1 to 6, preferably 2 to 3, wherein at least two carbon atoms of two adjacent “CH₂” moieties may form a double bond,

x is 4 to 50, and

R¹ is C₁-C₄-alkyl, preferably C₁-C₂-alkyl,

wherein these poly(alkylamines) may further be derived at the terminal amine moieties with C₁-C₄-alkyl, fatty acids or alkoxylated;
in particular wherein the poly(alkylamine) is selected from the group consisting of oligo-N,N-bis-(3-aminopropyl) methylamin and poly-N,N-bis-(3-aminopropyl) methylamin.
In a preferred embodiment A6 of the first aspect, the asphaltene reactivator is present and is selected from the group consisting of mono glycidylether and -ester, di- and tri glycidylether, diglycidylether of polymeric alcohol, and mixtures thereof with catalysts such as N,N-dimethyl benzylamine, wherein the mono glycidylether and -ester, di- and tri glycidylether, diglycidylether of polymeric alcohol have the structure of formula (5a), (5b), (5c), and 5(d)

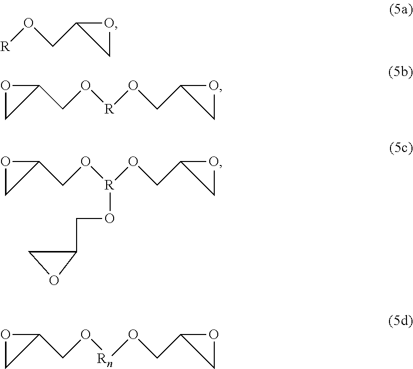

wherein

for formula (5a)

R is C₁-C₂₀-alkoxy, C₂-C₂₀-alkenyloxy, phenoxy, or C₁-C₂₀-carboxyalkyl, wherein the phenoxy may be further substituted with at least one C₁-C₁₅-alkyl, preferably C₄-C₁₆-alkoxy, preferably 2-ethylhexanolate, n-butanolate, tert.-butanolate, C₁₂-C₁₅-alkoxy, nonylphenolate, allyl alcoholate, or neodecanoic carboxylate;

for formula (5b)

R is straight C₅-C₂₀-alkylene which may be further substituted with at least one C₁-C₅-alkyl or C₁-C₄-alkylene, which is further substituted with at least one C₁-C₁₀-alkyl and/or at least one phenyl, preferably straight C₅-C₁₅-alkylene which may be further substituted with at least one C₁-C₄-alkyl or a C₁-C₃-alkylene, which is further substituted with at least one C₁-C₅-alkyl and/or at least one phenyl;

for formula (5c)

R is C₁-C₅-alkylene, preferably C₃-alkylene; and

for formula (5d)

Rₙ has the formulae (6a), (6b), or (6c)

(—CH₂CH₂O—)ₙ (6a),

wherein n is 3 to 20,

(—CH₂CH(CH₃)O—)ₙ (6b),

wherein n is 3 to 18, preferably 3 to 15, or

(—CH₂CH₂CH₂CH₂O—)ₙ (6c)

wherein n is 3 to 18, preferably 3 to 15;
preferably wherein the asphaltene reactivator is selected from the group consisting of polyethyleneglycol bis(glycidyl)ether, polypropyleneglycol bis(glycidyl)ether, neopentylglycol bis glycidylether, 2-methyl-2-phenyl-1,3-propandiol bis glycidylether, 2-ethylhexyl glycidyl ether, as well as mixtures of these compounds with catalysts such as N,N-dimethyl benzylamine; more preferably wherein the asphaltene reactivator is polypropyleneglycol bis(glycidyl)ether.
In a preferred embodiment A7 of the first aspect, the maltene reactivator is present and is a plasticizer having the formula (7a), (7b), (7c), (7d), or (7e),

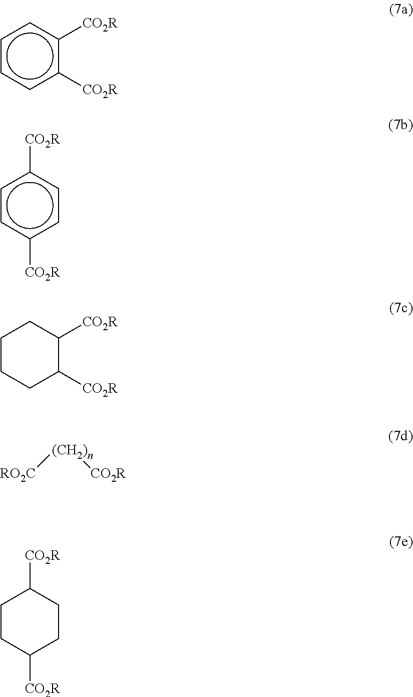

wherein

for formula (7a)

R is C₄-C₁₄-alkyl or C₄-C₁₄-alkenyl;

for formula (7b)

R is C₄-C₁₄-alkyl or C₄-C₁₄-alkenyl;

for formula (7c)

R is C₄-C₁₄-alkyl or C₄-C₁₄-alkenyl;

for formula (7d)

R is C₄-C₁₄-alkyl or C₄-C₁₄-alkenyl;

for formula (7e)

R is C₄-C₁₄-alkyl or C₄-C₁₄-alkenyl, and

n is 4 to 10, wherein at least two carbon atoms of two adjacent “CH₂” moieties may form a double bond, preferably wherein the plasticizer has the formula (7a), (7c), or (d), wherein

for formula (7a)

R is C₈-C₁₂-alkyl or C₇-C₁₂-alkenyl, preferably C₈-C₁₁-alkyl;

for formula (7c)

R is C₈-C₁₂-alkyl or C₇-C₁₂-alkenyl, preferably C₈-C₁₁-alkyl;

for formula (7d)

R is C₈-C₁₂-alkyl or C₇-C₁₂-alkenyl, preferably C₈-C₁₁-alkyl, and

n is 4 to 8, wherein at least two carbon atoms of two adjacent “CH₂” moieties may form a double bond, more preferably wherein the maltene reactivator is selected from the group consisting of diisononyl phthalate or diisononyl cyclohexane-1,2-dicarboxylate, more preferably wherein the maltene reactivator is diisononyl cyclohexane-1,2-dicarboxylate.

In a preferred embodiment A8 of the first aspect, the bituminous binder comprises reclaimed asphalt pavement and/or reclaimed asphalt shingles binder from 10 to 100 wt.-%, based on the total weight of the bituminous binder.

In a preferred embodiment A9 of the first aspect, the bituminous binder comprises further additives, preferably wherein the further additives are selected from the group consisting of polymers, waxes, fibers, or mixtures thereof.

In a second aspect, the present invention relates to an asphalt composition comprising aggregate and the binder composition as claimed.

In a third aspect, the present invention relates to a paved road surface, road subsurface, runway, driveway, parking lot, road shoulder, bridge, bridge abutment, roofing, bank revetment, or unpaved road comprising the asphalt composition as claimed.

In a fourth aspect, the present invention relates to a method for evaluating the efficiency of a rejuvenating agent in a binder composition, wherein the efficiency of the rejuvenating agent is proven via

(i) the loss tangent before or after ageing, obtained from a dynamic shear rheometer (DSR) frequency sweep at a defined temperature, wherein the frequency sweep is measured at a temperature from 0 to 90° C. and wherein an effective rejuvenating agent fulfills inequation (a)

loss tangent[bc]>1.3×loss tangent [bb], (a)

wherein loss tangent[bc] denotes the loss tangent of the binder composition and loss tangent [bb] denotes the bituminous binder and wherein loss tangent[bc] and loss tangent [bb] are evaluated at a frequency from 0.01 to 10 rad/s, or

(ii) TD NMR relaxation experiments performed on bitumen samples at a temperature of from −50 to 200° C. and wherein an effective rejuvenating agent fulfills inequation (aa1)

T2e1[bc]>1.3×T2e1[bb] (aa1)

wherein T2e1[bc] denotes the relaxation times that correspond to the individual component of the binder composition and T2e1[bb] denotes the relaxation times that correspond to the individual component of the bituminous binder.

In a fifth aspect, the present invention relates to the use of a rejuvenating agent comprising at least an asphaltene dispersant, which is selected from the group consisting of alkoxylates, N,N-dialkylamides of aliphatic carboxylic acids, N-alkyl lactames, and poly(alkylamines), an asphaltene reactivator, which is selected from the group consisting of mono glycidylether and -ester, di- and tri glycidylether, diglycidylether of polymeric alcohol, and mixtures thereof with catalysts, a maltene reactivator, which is a plasticizer, or mixtures thereof for recycling Reclaimed Asphalt Pavement (RAP) and/or asphalt shingles from roofing (RAS).

### FIGURES

FIG. 1 discloses that the rejuvenating agents according to the present invention increase the loss tangent.

FIG. 2 discloses the tan δ after 3×RTFOT ageing of bitumen 20/30 rejuvenated with 5% of some of the herein claimed rejuvenating agents or the benchmark Rheofalt® HP-AM.

FIG. 3 discloses the tan δ of RTFOT+PAV aged bitumen 50/70 (BP) rejuvenated with 5% of some of the herein claimed rejuvenating agents or the benchmark Rheofalt® HP-AM.

FIG. 4 discloses the tan δ of RTFOT+PAV aged bitumen 50/70 (Schwedt) rejuvenated with 5% of some of the here claimed rejuvenating agents or the benchmark Rheofalt® HP-AM.

FIG. 5 discloses the tan δ of RAP bitumen rejuvenated with 5% of some of the here claimed rejuvenating agents or the benchmark Rheofalt® HP-AM.

FIG. 6 discloses the tan δ of Olexobit 45 rejuvenated with 5% of some of the here claimed rejuvenating agents or the benchmark Rheofalt® HP-AM.

FIG. 7 discloses the tan δ of Olexobit 45 rejuvenated with 5% of some of the here claimed rejuvenating agents or the benchmark Rheofalt® HP-AM, after 3×RTFOT.

### DETAILS DESCRIPTION

Before describing in detail exemplary embodiments of the present invention, definitions important for understanding the present invention are given.

As used in this specification and in the appended claims, the singular forms of “a” and “an” also include the respective plurals unless the context clearly dictates otherwise. In the context of the present invention, the terms “about” and “approximately” denote an interval of accuracy that a person skilled in the art will understand to still ensure the technical effect of the feature in question. The term typically indicates a deviation from the indicated numerical value of ±20%, preferably ±15%, more preferably ±10%, and even more preferably ±5%. It is to be understood that the term “comprising” is not limiting. For the purposes of the present invention the term “consisting of” is considered to be a preferred embodiment of the term “comprising of”. If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(a)”, “(b)”, “(c)”, “(d)”, “i”, “ii” etc. relate to steps of a method or use or assay there is no time or time interval coherence between the steps, i.e. the steps may be carried out simultaneously or there may be time intervals of seconds, minutes, hours, days, weeks, months or even years between such steps, unless otherwise indicated in the application as set forth herein above or below. It is to be understood that this invention is not limited to the particular methodology, protocols, reagents etc. described herein as these may vary. It is also to be understood that the terminology used herein is for the purpose of describing particular embodiments only, and is not intended to limit the scope of the present invention that will be limited only by the appended claims. Unless defined otherwise, all technical and scientific terms used herein have the same meanings as commonly understood by one of ordinary skill in the art.

When referring to compositions and the weight percent of the therein comprised ingredients it is to be understood that according to the present invention the overall amount of ingredients does not exceed 100% (±1% due to rounding).

The term “alkyl” as used herein denotes in each case a straight-chain or branched alkyl group having usually from 1 to 25 carbon atoms, preferably from 1 to 22 carbon atoms, more preferably 1 to 18 carbon atoms, and even more preferably 1 to 15 carbon atoms.

The term “alkenyl” as used herein denotes in each case an unsaturated, straight-chain or branched hydrocarbon group having usually 2 to 25, preferably 2 to 22 carbon atoms, more preferably 2 to 18 carbon atoms, and even more preferably 2 to 15 carbon atoms, comprising at least one carbon-carbon double bond in any position. If geometric isomers are possible with regard to the double bond, the present invention relates to both, the E- and Z-isomers.

The term “alkoxy” as used herein denotes in each case a straight-chain or branched alkyl group which is bonded via an oxygen atom and has usually from 1 to 25 carbon atoms.

The term “alkenyloxy” as used herein denotes in each case a straight-chain or branched alkenyl group which is bonded via an oxygen atom and has usually from 2 to 25 carbon atoms.

The term “carboxyalkyl” as used herein denotes in each case a straight-chain or branched alkyl group which is bonded via an oxygen atom of a carboxy group and has usually from 1 to 25 carbon atoms.

As used herein, the term “alkylene” refers to a linking straight-chain or branched alkylene group having usually from 1 to 15 carbon atoms. The alkylene group bridges certain groups of the molecule. According to the present invention, alkylene groups may bridge two or three groups of the molecule. A skilled person understands that, if it is referred, e.g., to CH₂ that the carbon atom being tetravalent has two valences left for forming a bridge (—CH₂—). Similarly, when it is referred, e.g., to CH₂CH₂, each carbon atom has one valence left for forming a bridge (—CH₂CH₂—) or expressed via (—C₂H₄—).

The term “alkyl phenyl” as used herein denotes in each case a phenyl, which may be substituted with at least one alkyl group.

The term “phenoxy” or “phenyloxy” as used herein refers to the corresponding group (i.e. phenyl), which is bonded to the remainder of the molecule via an oxygen atom.

The term “(Cn-Cm-alkyl)” as used herein denotes in each case a linker moiety, wherein the thereto attached moieties are attached to the terminal carbons.

The term “asphalt” as used herein refers to the composite material comprising “aggregates” and “bitumen” and being used e.g. in road paving or roofing. The most common application of asphalt is for paving applications. Different grades of asphalt are defined for these paving applications—mainly with very well specified compositions for the aggregates, which form with 92.5-96 wt. % the by far bigger part. Typically, the amount of bitumen is from 4-7.5 wt. %. However, even being the smaller part of the composition, the property profile of the bitumen has a huge impact on the performance profile of the asphalt.

The term “reclaimed asphalt” as used herein refers to any kind of asphalt reclaimed after use. Especially, “Reclaimed Asphalt Pavement (RAP)” obtained from pavements that have been removed from the road and “Reclaimed Asphalt Shingles (RAS)” or any other asphalt containing material from roofing applications should be named.

The term “bitumen” as used herein refers to the sticky, black, and highly viscous liquid or semi-solid material as obtained as residue in petrochemical refineries or as found in natural deposits.

The term “fresh bitumen” as used herein refers to bitumen as derived from the refinery and which has not been used in road paving, roofing or any other application before. In this connection it is to be understood that fresh bitumen has not aged.

The term “virgin binder” refers to “fresh bitumen” without a rejuvenating agent (being thus not rejuvenated) and to “fresh bitumen” comprising at least one rejuvenating agent. In this connection it is to be understood that virgin binder has not aged. The virgin binder can further contain at least one additive from the group consisting of polymers, waxes, fibers, or antistripping agents.

The term “aged bitumen” as used herein refers to the bitumen present in or is recovered from reclaimed asphalt. Due to ageing processes aged bitumen exhibits e.g. a higher viscosity and a higher softening point as the corresponding fresh bitumen having been used for manufacturing asphalt. Normally, the aged bitumen is not isolated from the reclaimed asphalt. The chemical composition of aged bitumen, as characterized by the SARA-analysis, shows a significant increase in the asphaltene content, being the major impact for the deterioration of the bitumen. The aged binder is normally not isolated from reclaimed asphalt for the production of new asphalt using RAP. Instead, the reclaimed asphalt is mixed with the rejuvenating agents in an appropriate manner at the asphalt mixing plant together with or without fresh bitumen (forming the binder composition) and with or without aggregates. Only on the lab scale the aged binder is isolated from reclaimed asphalt (typically by solvent extraction) in order to investigate the function of the rejuvenating agents and to decide on the optimum composition and dosage of the rejuvenating agents.

The term “aggregate” as used is defined as a coarse over medium to finely grained material used in construction as e.g. sand, gravel, crushed stone or slag and is based on e.g. limestone, granite, basalt or quartzite.

The term “binder composition” as used herein refers to a mixture of fresh and/or aged bitumen (i.e. bituminous binder) and optionally other components as e.g. polymers, adhesion promoters, rejuvenating agents or other suitable additives. According to the present invention, the binder composition also contains at least one rejuvenating agent.

The term “rejuvenating agents” as used herein refers to compositions or chemical compounds that are mixed in appropriate manner with aged bitumen and which allow to restore the property profiles of aged bitumen close to those of fresh bitumen.

Analytical Methods

The term “SARA-analysis” as used herein refers to the description of the chemical composition of bitumen. Typically, bitumen is described by its physical properties, especially the viscoelastic behavior. The description by its chemical composition is very complex, because it consists of a huge number of chemical individuals and their composition depends very much on the provenance of the bitumen. Nevertheless, for the description of the chemical composition of bitumen, the SARA-analysis is established in the asphalt industry. SARA reflects the four groups of chemicals, which are found in every bitumen: Saturates (non-polar, aliphatic and cycloaliphatic hydrocarbons), Aromatics (less polar, aromatic hydrocarbons), Resins (polar, condensed cycloaliphatic, aromatic and hetero-aromatic compounds—soluble in n-heptane) and asphaltenes (polar, condensed cycloaliphatic, aromatic and hetero-aromatic compounds—not soluble in heptane). For the performance profile of bitumen, a very well-balanced ratio between these SARA components is very important, with the asphaltenes playing a very important role.

“Rheology” is the study of the “deformation and flow of matter, especially the non-Newtonian flow of liquids and the plastic flow of solids.” For the mid- and high temperature range of rheological properties the binder rheology is most often, but not exclusively, characterized using DSR rheological measurements. The following rheological parameters are most typically analyzed:
The “softness” of the binder is an indication of its flexibility over a given temperature range. Experimentally, for bitumen it is typically derived from the “softening point ring & ball” (DIN EN 1427) or from the needle penetration test (DIN EN 1426).
The “viscosity” is an indication of the flowability of the binder. It is especially important during the production of bitumen as well as for the production of asphalt. For bitumen, the viscosity depends strongly on the temperature at which it is measured. The viscosity of bitumen is most typically determined using DSR rheological measurements using plate/plate geometries, and most often at 135° C. but also at other temperatures, e.g. 60° C. (DIN EN 12595, DIN EN 12596).
The “loss tangent” (also known as “loss factor” (tan δ)”) is the ratio between the viscous contribution G″ and the elastic contribution G′ of a viscoelastic binder. The loss tangent can for example, but not exclusively, be obtained from frequency sweeps at a defined temperature of a binder. As the loss tangent is the ratio between G″/G′ it is a direct indication of the mobility of the molecules within the binder (G″ itself is the viscous contribution, solely defined by the mobility of the binder), especially, but not exclusively, at low frequencies at which the impact of the rheological measurement itself onto the binder system is minimal, thereby directly studying the intrinsic mobility of the binder.
“Elasticity” is the elastic recovery as derived from the either the MSCR test or from the traditional elastic recovery (DIN EN 13398). The multiple stress creep recovery (“MSCR”) test (DIN EN 16659) gives an indication for the elastic recovery strength of a binder. After a stress is put on a binder confined within a plate/plate geometry, the test measures the capability of the binder to recover to the initial state before torsion. The higher the percentage recovery, the more elastic the system.
“Ductility” is a measure for the plastic deformability and cohesion of bitumen and is routinely measured with the force ductility test (DIN EN 13589) with the ductilimeter.
Even though recent studies suggest the “low temperature behavior” of bitumen can be approximated using DSR measurements at low temperature, it is generally believed that up until today the most reliable low-temperature test is still the bending beam rheometer (BBR) test (DIN EN 14771). Here, the two values flexural creep stiffness S and the m-value (value describing ability of the system to relax=slope of the curve of the logarithm of stiffness versus the logarithm of time at a given time) are determined.
“ageing behavior”: Rejuvenating agents have to withstand a new cycle of bitumen ageing, and it is important to determine the impact of the rejuvenating agent on the ageing behavior of bitumen. The ageing of the rejuvenating agent can be tested with the RTFOT ageing test (DIN EN 12607) on the binder composition and determination of the change of viscosity at 135° C. and/or the change of loss tangent due to ageing. The ageing can be characterized with the ageing index (AI) which is defined as the viscosity after ageing divided by the viscosity before ageing. To have a more precise result concerning the ageing behavior of the rejuvenating agent, we typically perform the prolonged RTFOT ageing test (3×RTFOT at 163° C.), a test that is known to the scientific community for being able to approximate the long-term stability of a binder. Another test known to approximate the long-term stability of a binder is the so-called Pressure Ageing Vessel (PAV, DIN EN 14769), in which the binder is aged under pressure (around 2.1 MPa) at an elevated temperature (between 85 to 110° C.) for a prolonged period (usually 20 h).

Preferred embodiments regarding the binder compositions and the use thereof are described in detail hereinafter. It is to be understood that the preferred embodiments of the invention are preferred alone or in combination with each other.

As indicated above, the present invention relates in one embodiment to a binder composition comprising

(a) a bituminous binder; and

(b) a rejuvenating agent from 0.05 to 20 wt.-%, based on the total amount of the binder composition,

wherein the rejuvenating agent comprises at least an asphaltene dispersant, an asphaltene reactivator, a maltene reactivator, or mixtures thereof.

Without wishing to be bound to any theory, bitumen according to the present invention is regarded as a dispersion of polar micelles in a continuous hydrocarbon medium (=“maltenes” or “maltene phase”). In this model the “maltenes” comprise inter alia “saturates” and “aromatics” based on e.g. aliphatic, alicyclic and aromatic hydrocarbons with typically low number of hetero functionalities as e.g. alcohols, carboxylic acids, mercaptans or amines as well as “resins” (=less condensed aromatic or aromatic-cycloaliphatic systems with lower molecular weight as the asphaltenes and having some degree of polarity). The micelles are based on “asphaltenes” (=condensed aromatic systems with higher molecular weight and higher polarity caused by a higher number of hetero functionalities), surrounded by the “resins”. These resins play an important role in the stabilization of the colloidal system and therefore also in any rejuvenation process.

Only very few crude oils (approx. 100 out of more than 1500) deliver a residue after vacuum distillation suitable for bitumen applications and especially asphalt manufacturing. This is thought to be related to a minimum content of “asphaltenes” and well-balanced ratios between “maltenes” and “asphaltenes”, specific for each crude oil source and resulting in the required rheological property profiles of bitumen. This balance is disrupted by ageing processes, especially by chemical oxidations, chain loss or condensations, shifting the rheological property profiles towards higher viscosities, and finally to increased brittleness of the material at lower temperatures, rendering the binder no longer suitable for e.g. asphalt paving applications.

Even though sometimes claimed, rejuvenating agents are not thought to restore the exact virgin bitumen composition. However, the rejuvenating agents according to the present invention enable a new balance between “saturates”, “aromatics”, “resins”, and “asphaltenes”, resulting in property profiles close to those of a virgin bitumen.

With increasing amounts of reclaimed asphalt utilized and reclaimed asphalt being recycled multiple times, the need to restore the properties of the bitumen phase will increase in order to ensure the required asphalt performance also in the future.

An asphaltene dispersant according to the present invention is a chemical or a composition comprising said chemical improving the dispersion of the asphaltene with the micelles. In particular, an asphaltene dispersant either breaks down the asphaltene stacks to shorter asphaltene aggregates or improves the dispersion of the asphaltene stacks within the maltene phase. In this connection alkoxylates, N,N-dialkylamides of aliphatic carboxylic acids, N-alkyl lactames, and poly(alkylamines) are to be named. Asphaltene dispersants having no toxicology labeling are preferred.

In one embodiment of the present invention, the alkoxylates have the structure of formula (1)

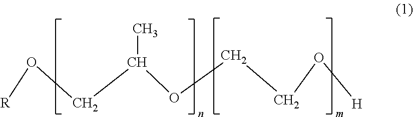

wherein

R is H, C₁-C₂₂-alkyl, C₂-C₂₂-alkenyl, phenyl, or alkyl phenyl,

n is 0 to 20,

m is 0 to 20, and wherein

n+m≥1.

In a preferred embodiment of the present invention, the alkoxylates have the structure of formula (1), wherein

R is H or C₁-C₂₂-alkyl, preferably H or C₁-C₁₈-alkyl, and more preferably H or C₄-C₁₃-alkyl,

n is 0 to 20, preferably 0 to 15, more preferably 0 to 10,

m is 0 to 20, preferably 0 to 15, more preferably 0 to 10, and wherein

n+m≥1, preferably n+m≥5.

In a particular embodiment of the present invention, the alkoxylates have the structure of formula (1), wherein

R is C₁₀-alkyl or C₁₃-alkyl, preferably 2-propyl heptyl or isotridecyl,

n is 0 to 6,

m is 0 to 8, and wherein

n+m≥5.

In one embodiment of the present invention, the N,N-dialkylamides of aliphatic carboxylic acids have the structure of formula (2)

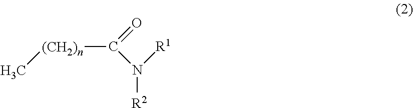

wherein

n is 3 to 16, wherein the carbon atom of at least one “CH₂” moiety may be further substituted with at least one C₁-C₅-alkyl and wherein at least two carbon atoms of two adjacent “CH₂” moieties may form a double bond,

R¹ is C₁-C₄-alkyl, and

R² is C₁-C₄-alkyl.

In a preferred embodiment of the present invention, the N,N-dialkylamides of aliphatic carboxylic acids have the structure of formula (2), wherein

n is 6 to 14, preferably 6 to 12, wherein the carbon atom of at least one “CH₂” moiety may be further substituted with at least one C₁-C₅-alkyl,

R¹ is C₁-C₄-alkyl, preferably methyl or ethyl, and

R² is C₁-C₄-alkyl, preferably methyl or ethyl.

In a particular embodiment of the present invention, the N,N-dialkylamides of aliphatic carboxylic acids have the structure of formula (2), wherein

n is 8 to 12,

R¹ is methyl or ethyl, and

R² is methyl or ethyl.

In one embodiment of the present invention, the N-alkyl lactames have the structure of formula (3)

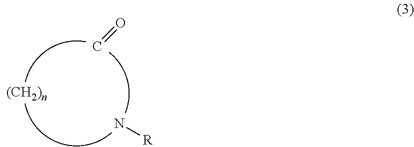

wherein

n is 3 to 11, wherein the carbon atom of at least one “CH₂” moiety may be further substituted with at least one C₁-C₃-alkyl, and

R is C₁-C₂₂-alkyl or C₂-C₂₂-alkenyl.

In a preferred embodiment of the present invention, the N-alkyl lactames have the structure of formula (3), wherein

n is 3 (pyrrolidone), 5 (caprolactam), or 11 (laurolactam), and

R is C₁-C₂₂-alkyl, preferably C₄-C₁₈-alkyl, more preferably C₈-C₁₂-alkyl.

In a particular embodiment of the present invention, the N-alkyl lactames have the structure of formula (3), wherein

n is 3 (pyrrolidone), and

R is C₈-C₁₂-alkyl.

In one embodiment of the present invention, the poly(alkylamines) have the structure of formula (4)

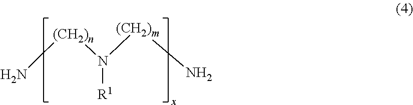

wherein

n is 1 to 6, wherein at least two carbon atoms of two adjacent “CH₂” moieties may form a double bond,

m is 1 to 6, wherein at least two carbon atoms of two adjacent “CH₂” moieties may form a double bond,

x is 4 to 50, and

R¹ is C₁-C₄-alkyl,

wherein these poly(alkylamines) may further be derived at the terminal amine moieties with C₁-C₄-alkyl, fatty acids or alkoxylated.

In a preferred embodiment of the present invention, the poly(alkylamines) have the structure of formula (4), wherein

n is 1 to 6, preferably 2 to 3,

m is 1 to 6, preferably 2 to 3,

x is 4 to 50, and

R¹ is C₁-C₂-alkyl,

wherein these poly(alkylamines) may further be derived at the terminal amine moieties with fatty acids or alkoxylated.

In a particular embodiment of the present invention, the poly(alkylamine) is selected from the group consisting of oligo-N,N-bis-(3-aminopropyl) methylamin and poly-N,N-bis-(3-aminopropyl) methylamin (also referred to as poly(bis aminopropyl amine) or PolyBAPMA in the following).

As above-indicated, according to the present invention, the poly(alkylamines) having the formula (4) may further be derived at the terminal amine moieties with fatty acids.

In one embodiment of the present invention, the poly(alkylamines) have the structure of formula (4a)

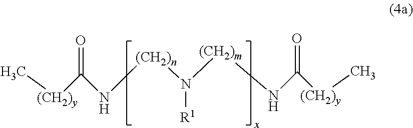

wherein

n is 1 to 6, preferably 2 to 3, wherein at least two carbon atoms of two adjacent “CH₂” moieties may form a double bond,

m is 1 to 6, preferably 2 to 3, wherein at least two carbon atoms of two adjacent “CH₂” moieties may form a double bond,

x is 4 to 50,

R¹ is C₁-C₄-alkyl, preferably C₁-C₂-alkyl, and

y is 10 to 20.

As above-indicated, according to the present invention, the poly(alkylamines) having the formula (4) may further be derived at the terminal amine moieties via alkoxylation.

In one embodiment of the present invention, the poly(alkylamines) have the structure of formula (4b)

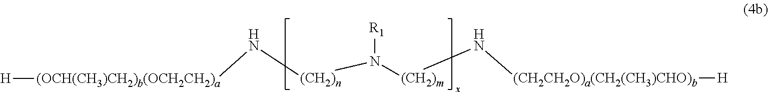

wherein

n is 1 to 6, preferably 2 to 3, wherein at least two carbon atoms of two adjacent “CH₂” moieties may form a double bond,

m is 1 to 6, preferably 2 to 3, wherein at least two carbon atoms of two adjacent “CH₂” moieties may form a double bond,

x is 4 to 50,

R¹ is C₁-C₄-alkyl, preferably C₁-C₂-alkyl, and

a +b≥1≤10.

Suitable examples of an asphaltene dispersant are Lutensol® TO 8, Lutensol® TO 3, Lutensol® TO 15, Disponil® FEP 3830 PA, Lutensol® XL 60, Lutensol® XP 70, Agnique® AMD 12, Lutensol® TO 5, Pluriol® A 500 PE, polyBAPMA, with partly varying MW's as well as their possible fatty acid amide derivatives e.g. after reaction with stearic acid, N-dodecyl pyrrolidone and N,N-dimethyl dodecanoic acid amide.

In one preferred embodiment of the present invention, the asphaltene dispersant is an alkoxylate having the structure of formula (1)

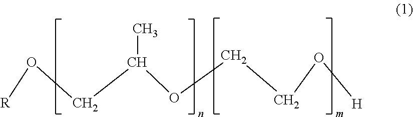

wherein

R is H, C₁-C₂₂-alkyl, C₂-C₂₂-alkenyl, phenyl, or alkyl phenyl,

n is 0 to 20,

m is 0 to 20, and wherein

n+m≥1,

poly(bis aminopropyl amine) (polyBAPMA), or N-dodecyl pyrrolidone.

An asphaltene reactivator according to the present invention is a chemical or a composition comprising said chemical which through chemical attachment of organic chains, such as alkene chains, to asphaltenes, increases the solubility of the asphaltenes within the maltenes, after having lost their solubility as a result of the ageing process of the binder. The mode of action of the asphaltene reactivator is a chemical reaction with functional groups of the asphaltenes and by that working against the asphaltene agglomeration. Preferred asphaltene reactivators have no toxicological labeling. In this connection mono glycidylether and -ester, di- and tri glycidylether, diglycidylether of polymeric alcohol, and mixtures thereof with catalysts such as N,N-dimethyl benzylamine are to be named.

In one embodiment of the present invention, the mono glycidylether and -ester, di- and tri glycidylether, diglycidylether of polymeric alcohol have the structure of formula (5a), (5b), (5c), and 5(d)

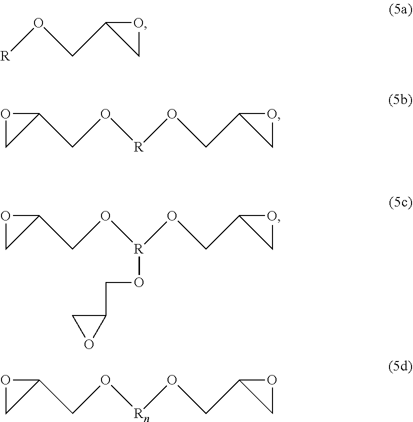

wherein

for formula (5a)

R is C₁-C₂₀-alkoxy, C₂-C₂₀-alkenyloxy, phenoxy, or C₁-C₂₀-carboxyalkyl, wherein the phenoxy may be further substituted with at least one C₁-C₁₅-alkyl;

for formula (5b)

R is straight C₅-C₂₀-alkylene which may be further substituted with at least one C₁-C₅-alkyl or C₁-C₄-alkylene, which is further substituted with at least one C₁-C₁₀-alkyl and/or at least one phenyl;

for formula (5c)

R is C₁-C₅-alkylene; and

for formula (5d)

Rₙ has the formulae (6a), (6b), or (6c)

(—CH₂CH₂O—), (6a),

wherein n is 3 to 20,

(—CH₂CH(CH₃)O—)ₙ (6b),

wherein n is 3 to 18, or

(—CH₂CH₂CH₂CH₂O—)ₙ (6c)

wherein n is 3 to 18.

In a preferred embodiment of the present invention, the mono glycidylether and -ester, di- and tri glycidylether, diglycidylether of polymeric alcohol have the structure of formula (5a), (5b), (5c), and 5(d),

wherein

for formula (5a)

R is C₄-C₁₆-alkoxy, preferably 2-ethylhexanolate, n-butanolate, tert.-butanolate, C₁₂-C₁₅-alkoxy, nonylphenolate, allyl alcoholate, or neodecanoic carboxylate,

for formula (5b)

R is straight C₅-C₁₅-alkylene which may be further substituted with at least one C₁-C₄-alkyl or a C₁-C₃-alkylene, which is further substituted with at least one C₁-C₅-alkyl and/or at least one phenyl, preferably (—C₆H₁₂—), (—CH₂C(CH₃)₂CH₂—), and (—CH₂C(CH₃)(C₆H₆)CH₂—);

for formula (5c)

R is C₃-alkylene, preferably (—C₃H₆—); and

for formula (5d)

Rₙ has the formulae (6a), (6b), or (6c)

(—CH₂CH₂O—), (6a),

wherein n is 3 to 20,

(—CH₂CH(CH₃)O—)ₙ (6b),

wherein n is 3 to 15, or

(—CH₂CH₂CH₂CH₂O—)ₙ (6c)

wherein n is 3 to 15.

In another preferred embodiment of the present invention, the mono glycidylether, di- and tri glycidylether, diglycidylether of polymeric alcohol have the structure of formula (5b), (5c), and 5(d),

wherein

for formula (5b)

R is (—C₆H₁₂—), (—CH₂C(CH₃)₂CH₂—), and (—CH₂C(CH₃)(C₆H₆)CH₂—);

for formula (5c)

R is (—C₃H₆—); and

for formula (5d)

Rₙ has the formulae (6a), (6b), or (6c)

(—CH₂CH₂O—), (6a),

wherein n is 3 to 20,

(—CH₂CH(CH₃)O—)ₙ (6b),

wherein n is 3 to 15, or

(—CH₂CH₂CH₂CH₂O—)ₙ (6c)

wherein n is 3 to 15.

In a preferred embodiment of the present invention, the glycidylether has the structure of formula 5(d), wherein R has the formulae (6a), (6b), or (6c)

(—CH₂CH₂O—)ₙ (6a),

wherein n is 3 to 20,

(—CH₂CH(CH₃)O—)ₙ (6b),

wherein n is 3 to 15, or

(—CH₂CH₂CH₂CH₂O—)ₙ (6c)

wherein n is 3 to 15.

In a particular embodiment of the present invention, the glycidylether has the structure of formula 5(d), wherein

R has the formulae (6b) or (6c)

(—CH₂CH(CH₃)O—)ₙ (6b),

wherein n is 3 to 15, or

(—CH₂CH₂CH₂CH₂O—)ₙ (6c)

wherein n is 3 to 15.

Most preferred are glycidylethers having the structure of formula (5d), wherein R has the formula (6b)

(—CH₂CH(CH₃)O—)ₙ (6b),

wherein n is 3 to 12.

Suitable examples of an asphaltene reactivator are bis(glycidyl)ethers such as polyethyleneglycol bis(glycidyl)ether and polypropyleneglycol bis(glycidyl)ether, 2-ethylhexyl glycidyl ether, 2-methyl-2-phenyl-1,3-propandiol bis glycidylether (MPPD-DGE), neopentyl glycol diglycidyl ether (also known as neopentylglycol bis glycidylether), as well as mixtures of these compounds with catalysts such as N,N-dimethyl benzyl amine.

In one embodiment of the present invention, the asphaltene reactivator is selected from the group consisting of polyethyleneglycol bis(glycidyl)ether, polypropyleneglycol bis(glycidyl)ether, neopentylglycol bis glycidylether, 2-methyl-2-phenyl-1,3-propandiol bis glycidylether, 2-ethylhexyl glycidyl ether, as well as mixtures of these compounds with catalysts, preferably wherein the asphaltene reactivator is polypropyleneglycol bis(glycidyl)ether.

A maltene reactivator according to the present invention is a chemical or a composition comprising said chemical which not only replenishes the maltene phase but also (re-)establishes colloidal stability within the binder through combined action of pi-pi interaction, polar interactions and Van der Waals interactions. According to the present invention, the maltene reactors are plasticizers. Preferred maltene reactivators have no toxicological labeling. Suitable examples of maltene reactivator are Palatinol® DINP or Hexamoll® DINCH.

In one embodiment of the present invention, the plasticizer has the formula (7a), (7b), (7c), (7d), or (7e),

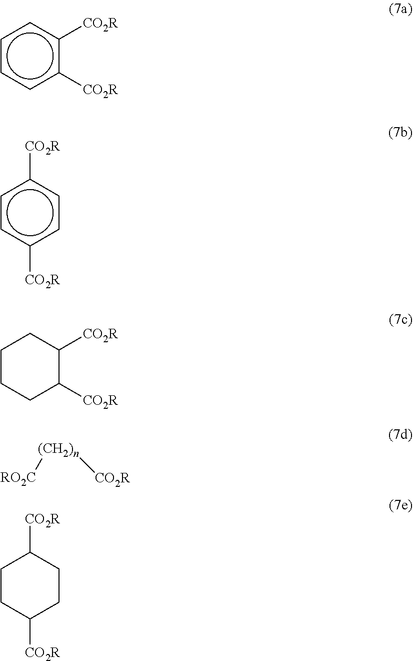

wherein

for formula (7a)

R is C₄-C₁₄-alkyl or C₄-C₁₄-alkenyl;

for formula (7b)

R is C₄-C₁₄-alkyl or C₄-C₁₄-alkenyl;

for formula (7c)

R is C₄-C₁₄-alkyl or C₄-C₁₄-alkenyl;

for formula (7d)

R is C₄-C₁₄-alkyl or C₄-C₁₄-alkenyl;

for formula (7e)

R is C₄-C₁₄-alkyl or C₄-C₁₄-alkenyl, and

n is 4 to 10, wherein at least two carbon atoms of two adjacent “CH₂” moieties may form a double bond.

In a preferred embodiment of the present invention, the plasticizer has the formula (7a), (7c), or (d), wherein

for formula (7a)

R is C₈-C₁₂-alkyl or C₇-C₁₂-alkenyl, preferably C₈-C₁₁-alkyl;

for formula (7c)

R is C₈-C₁₂-alkyl or C₇-C₁₂-alkenyl, preferably C₈-C₁₁-alkyl;

for formula (7d)

R is C₈-C₁₂-alkyl or C₇-C₁₂-alkenyl, preferably C₈-C₁₁-alkyl, and

n is 4 to 8, wherein at least two carbon atoms of two adjacent “CH₂” moieties may form a double bond.

In a more preferred embodiment of the present invention, the plasticizer has the formula (7a), (7c), or (d), wherein

for formula (7a)

R is C₉-C₁₀-alkyl, preferably 2-propyl heptyl or isononyl;

for formula (7c)

R is C₉-C₁₀-alky, preferably 2-propyl heptyl or isononyl;

for formula (7d)

R is C₉-C₁₀-alky, preferably 2-propyl heptyl or isononyl, and

n is 4 to 6, preferably 4.

In a particular embodiment of the present invention, the plasticizer has the formula (7c) wherein

for formula (7c)

R is C₉-C₁₀-alky, preferably 2-propyl heptyl or isononyl, more preferably isononyl.

According to the present invention, preferred maltene reactivators are selected from the group consisting of diisononyl phthalate or diisononyl cyclohexane-1,2-dicarboxylate, more preferably diisononyl cyclohexane-1,2-dicarboxylate.

In one embodiment of the present invention, the binder composition comprises

an asphaltene dispersant, which is selected from the group consisting of alkoxylates, N,N-dialkylamides of aliphatic carboxylic acids, N-alkyl lactames, and poly(alkylamines), preferably wherein the asphaltene dispersant is selected from the group consisting of alkoxylates having the structure of formula (1)

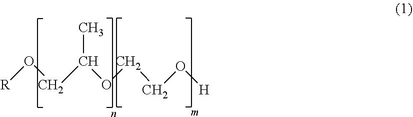

wherein

R is H, C₁-C₂₂-alkyl, C₂-C₂₂-alkenyl, phenyl, or alkyl phenyl,

n is 0 to 20,

m is 0 to 20, and wherein

n+m≥1;

N,N-dialkylamides of aliphatic carboxylic acids having the structure of formula (2)

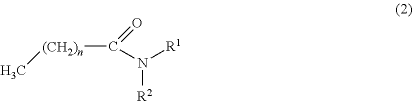

wherein

n is 3 to 16, wherein the carbon atom of at least one “CH₂” moiety may be further substituted with at least one C₁-C₅-alkyl and wherein at least two carbon atoms of two adjacent “CH₂” moieties may form a double bond,

R¹ is C₁-C₄-alkyl, and

R² is C₁-C₄-alkyl;

N-alkyl lactames having the structure of formula (3)

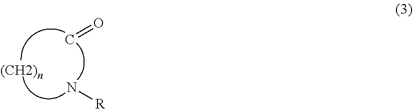

wherein

n is 3 to 11, wherein the carbon atom of at least one “CH₂” moiety may be further substituted with at least one C₁-C₃-alkyl, and

R is C₁-C₂₂-alkyl or C₂-C₂₂-alkenyl; or

poly(alkylamines) having the structure of formula (4)

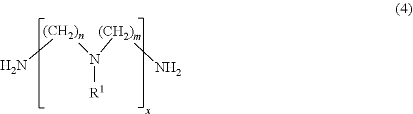

wherein

n is 1 to 6, wherein at least two carbon atoms of two adjacent “CH₂” moieties may form a double bond,

m is 1 to 6, wherein at least two carbon atoms of two adjacent “CH₂” moieties may form a double bond,

x is 4 to 50, and

R¹ is C₁-C₄-alkyl,

wherein these poly(alkylamines) may further be derived at the terminal amine moieties with C₁-C₄-alkyl, fatty acids or alkoxylated;
and/or an asphaltene reactivator, which is selected from the group consisting of mono glycidylether and -ester, di- and tri glycidylether, diglycidylether of polymeric alcohol, and mixtures thereof with catalysts such as N,N-dimethyl benzylamine; preferably wherein mono glycidylether and -ester, di- and tri glycidylether, diglycidylether of polymeric alcohol have the structure of formula (5a), (5b), (5c), and 5(d)

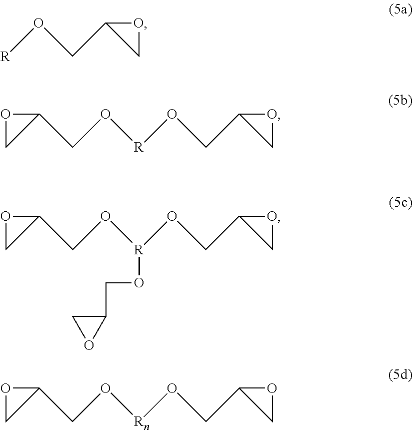

wherein

for formula (5a)

R is C₁-C₂₀-alkoxy, C₂-C₂₀-alkenyloxy, phenoxy, or C₁-C₂₀-carboxyalkyl, wherein the phenoxy may be further substituted with at least one C₁-C₁₅-alkyl;

for formula (5b)

R is straight C₅-C₂₀-alkylene which may be further substituted with at least one C₁-C₅-alkyl or C₁-C₄-alkylene, which is further substituted with at least one C₁-C₁₀-alkyl and/or at least one phenyl;

for formula (5c)

R is C₁-C₅-alkylene; and

for formula (5d)

Rₙ has the formulae (6a), (6b), or (6c)

(—CH₂CH₂O—)ₙ (6a),

wherein n is 3 to 20,

(—CH₂CH(CH₃)O—)ₙ (6b),

wherein n is 3 to 18, or

(—CH₂CH₂CH₂CH₂O—)ₙ (6c)

wherein n is 3 to 18;
and/or a maltene reactivator, which is a plasticizer, preferably having the formula (7a), (7b), (7c), (7d), or (7e),

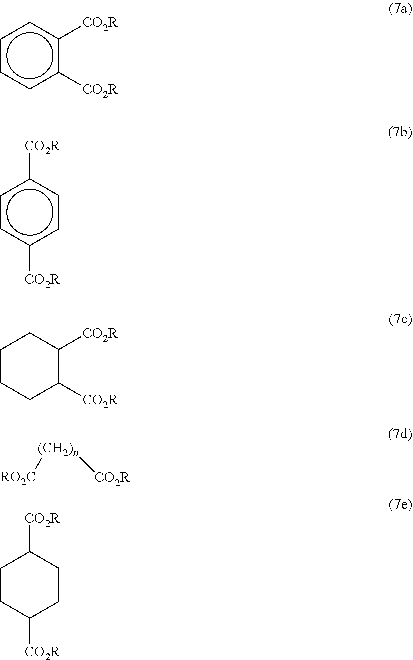

wherein
for formula (7a)
R is C₄-C₁₄-alkyl or C₄-C₁₄-alkenyl;

for formula (7b)

R is C₄-C₁₄-alkyl or C₄-C₁₄-alkenyl;

for formula (7c)

R is C₄-C₁₄-alkyl or C₄-C₁₄-alkenyl;

for formula (7d)

R is C₄-C₁₄-alkyl or C₄-C₁₄-alkenyl;

for formula (7e)

R is C₄-C₁₄-alkyl or C₄-C₁₄-alkenyl, and

n is 4 to 10, wherein at least two carbon atoms of two adjacent “CH₂” moieties may form a double bond.

In a particular embodiment of the present invention, the rejuvenating agent is selected from the group consisting of alkoxylates having the structure of formula (1)

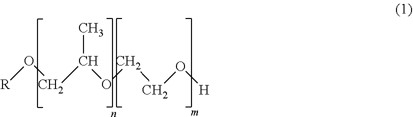

wherein

R is C₁₀-alky or C₁₃-alkyl, preferably 2-propyl heptyl or isotridecyl,

n is 0 to 6,

m is 0 to 8, and wherein

n+m≥5, poly(bis aminopropyl amine), N-dodecyl pyrrolidone, polypropyleneglycol bis(glycidyl)ether, and diisononyl cyclohexane-1,2-dicarboxylate.

The rejuvenating agents according to the present invention are active on the microstructure level of the bituminous binder, compared to benchmarks that are mainly known for diluting the bituminous binder. In a preferred embodiment of the present invention, the rejuvenating agents improve the bituminous binder properties at all temperature ranges and/or have no negative or even positive effects on the ageing of the recycled bituminous binder. In a particular preferred embodiment of the invention, the rejuvenating agents are toxicologically safe.

In a preferred embodiment of the present invention, the rejuvenating agent introduces a microstructural change of the bitumen micellar structure. It is to be understood that the microstructural change is accompanied with an improvement of the workability (in particular the viscosity) of the bituminous binder after addition of the rejuvenating agent.

In one embodiment of the present invention, this microstructural change of the bitumen micellar structure is detected via the loss tangent. Hence, in a preferred embodiment of the present invention, the loss tangent of the binder composition is increased compared to the loss tangent of the bituminous binder. In this connection is to be understood that the binder composition according to the present invention is a rejuvenated binder composition (since it comprises a rejuvenating agent according to the present invention) and that the bituminous binder is a not rejuvenated bituminous binder. It is to be understood that the loss tangent is determined according to the present invention.

In a preferred embodiment of the present invention, the microstructural change of the bitumen micellar structure can be expressed by fulfilling inequation (a)

loss tangent[bc]>1.3×loss tangent [bb] (a),

more preferably by fulfilling inequation (b)

loss tangent[bc]>1.5×loss tangent [bb], (b),

and in particular by fulfilling inequation (c)

loss tangent[bc]>2×loss tangent [bb], (c)

wherein loss tangent[bc] denotes the loss tangent of the binder composition and loss tangent [bb] denotes the bituminous binder and wherein loss tangent[bc] and loss tangent [bb] are evaluated at a frequency from 0.01 to 10 rad/s, preferably at a frequency from 0.01 to 1 rad/s.

In one embodiment of the present invention the microstructural change of the bitumen micellar structure is alternatively or additionally detected via TD NMR. A microstructural change in the bitumen micellar structure leads to an increase of the amount of mobile component(s) and/or its/their mobility/ies. Thus, in a preferred embodiment of the present invention, the amount of the mobile components of the binder composition and/or their respective mobility as per TD NMR is increased compared to the amount of the mobile components of the bituminous binder and/or their respective mobility. In another preferred embodiment of the present invention, the amount of the solid components of the binder composition as per TD NMR is decreased compared to the amount of the solid components of the bituminous binder. In yet another preferred embodiment of the present invention the amount of the mobile components of the binder composition and/or their respective mobility as per TD NMR is increased compared to the amount of the mobile components of the bituminous binder and/or their respective mobility and the amount of the solid component of the binder composition as per TD NMR is decreased compared to the amount of the solid component of the bituminous binder.

In a preferred embodiment of the present invention, the microstructural change of the bitumen micellar structure can be expressed by fulfilling inequation (aa1)

T2e1[bc]>1.3×T2e1[bb] (aa1),

more preferably by fulfilling inequation (bb1)

T2e1[bc]>1.5×T2e1[bb] (bb1)

wherein T2e1[bc] denotes the relaxation times that correspond to the individual component of the binder composition and T2e1[bb] denotes the relaxation times that correspond to the individual component of the bituminous binder, each measured at 30° C.

In a preferred embodiment of the present invention, the microstructural change of the bitumen micellar structure can be expressed by fulfilling inequation (aa2)

pe1[bc]>1.05×pe1[bb] (aa2),

more preferably by fulfilling inequation (bb2)

pe1[bc]>1.1×pe1[bb] (bb2),

wherein pe1[bc] denotes the signal fraction of the individual component scaled in the range from 0 to 1 of the binder composition and pe1[bb] denotes the signal fraction of the individual component scaled in the range from 0 to 1 of the bituminous binder, each measured at 30° C.

In a preferred embodiment of the present invention, the microstructural change of the bitumen micellar structure can be expressed by fulfilling inequation (aa3)

T2g2[bc]>1.05×T2g2[bb] (aa3),

more preferably by fulfilling inequation (bb3)

T2g2[bc]>1.1×T2g2T2g2[bb] (bb3),

wherein T2g2[bc] denotes the relaxation times that correspond to the individual component of the binder composition and T2g2[bb] denotes the relaxation times that correspond to the individual component of the bituminous binder, each measured at 30° C.

In a preferred embodiment of the present invention, the microstructural change of the bitumen micellar structure can be expressed by fulfilling inequation (aa4)

pe1[bc]>1.05×pe1[bb] (aa4),

more preferably by fulfilling inequation (bb4)

pe1[bc]>1.1×pe1[bb] (bb4),

wherein pe1[bc] denotes the signal fraction of the individual component scaled in the range from 0 to 1 of the binder composition and pe1[bb] denotes the signal fraction of the individual component scaled in the range from 0 to 1 of the bituminous binder, each measured at 80° C.

In a preferred embodiment of the present invention, the microstructural change of the bitumen micellar structure can be expressed by fulfilling inequation (aa5)

T2e2[bc]>1.2×T2e2[bb] (aa5),

more preferably by fulfilling inequation (bb5)

T2e2[bc]>1.3×T2e2[bb] (bb5),

wherein T2e2[bc] denotes the relaxation times that correspond to the individual component of the binder composition and T2e2[bb] denotes the relaxation times that correspond to the individual component of the bituminous binder, each measured at 80° C.

In a preferred embodiment of the present invention, the microstructural change of the bitumen micellar structure can be expressed by fulfilling inequation (aa6)

T2e2[bc]>1.2×T2e2[bb] (aa6),

more preferably by fulfilling inequation (bb6)

T2e2[bc]>1.3×T2e2[bb] (bb6),

wherein T2e2[bc] denotes the relaxation times that correspond to the individual component of the binder composition and T2e2[bb] denotes the relaxation times that correspond to the individual component of the bituminous binder, each measured at 140° C.

In a preferred embodiment of the present invention, the microstructural change of the bitumen micellar structure can be expressed by fulfilling inequation (aa7)

T2e3[bc]>1.15×T2e3[bb] (aa7),

more preferably by fulfilling inequation (bb7)

T2e3[bc]>1.25×T2e3[bb] (bb7),

wherein T2e7[bc] denotes the relaxation times that correspond to the individual component of the binder composition and T2e3[bb] denotes the relaxation times that correspond to the individual component of the bituminous binder, each measured at 140° C.

In one embodiment, the binder composition comprises the rejuvenating agent from 0.05 to 20 wt.-%, preferably from 0.1 to 18 wt.-%, more preferably from 0.5 to 15 wt.-%, even more preferably from 1 to 13 wt.-%, still more preferably from 2 to 10 wt.-%, and in particular from 3 to 7 wt.-%, based on the total amount of the binder composition.

In one embodiment, the binder composition comprises the bituminous binder from 80 to 99.95 wt.-%, preferably from 82 to 99.9 wt.-%, more preferably from 85 to 99.5 wt.-%, even more preferably from 87 to 99 wt.-%, still more preferably from 90 to 98 wt.-%, and in particular from 93 to 97 wt.-%, based on the total amount of the binder composition.

In one embodiment of the present invention, the rejuvenating agent comprises

(i) the asphaltene dispersant from 1 to 100 wt. %, preferably from 20 to 100 wt.-%, more preferably from 40 to 100 wt.-%, still more preferably from 60 to 100 wt.-%, and in particular from 80 to 100 wt.-%, based on the total amount of the rejuvenating agent;
(ii) the asphaltene reactivator from 1 to 100 wt. %, preferably from 20 to 100 wt.-%, more preferably from 40 to 100 wt.-%, still more preferably from 60 to 100 wt.-%, and in particular from 80 to 100 wt.-%, based on the total amount of the rejuvenating agent;
(iii) the maltene reactivator from 1 to 100 wt. %, preferably from 20 to 100 wt.-%, more preferably from 40 to 100 wt.-%, still more preferably from 60 to 100 wt.-%, and in particular from 80 to 100 wt.-%, based on the total amount of the rejuvenating agent; or
(iv) a mixture consisting of at least two of the components from (i) to (iii) from 1 to 100 wt. %, preferably from 20 to 100 wt.-%, more preferably from 40 to 100 wt.-%, still more preferably from 60 to 100 wt.-%, and in particular from 80 to 100 wt.-%, based on the total amount of the rejuvenating agent.

The rejuvenating agent may also comprise at least two different asphaltene dispersants.

The rejuvenating agent may also comprise at least two different asphaltene reactivators.

The rejuvenating agent may also comprise at least two different maltene reactivators.

The rejuvenating agent may comprise a mixture of the asphaltene dispersant and the asphaltene reactivator.

The rejuvenating agent may comprise a mixture of the asphaltene dispersant and the maltene reactivator.

The rejuvenating agent may comprise a mixture of the asphaltene reactivator and the maltene reactivator.

The rejuvenating agent may comprise a mixture of the asphaltene dispersant, the asphaltene reactivator, and the maltene reactivator.

By the addition of an above-outlined amount of the rejuvenating agent, the then rejuvenated bitumen composition (i.e. the binder composition according to the present invention) has improved properties on one or more of the parameters selected from the group consisting of softness, viscosity, MSCR, loss tangent, elasticity, low-temperature behavior, and ageing behavior when compared with untreated (i.e. not rejuvenated) bitumen compositions and/or bitumen compositions which have been rejuvenated with benchmarks that are typical to the industry.

In one preferred embodiment of the present invention, the rejuvenating agent is non-toxic. In yet another preferred embodiment of the present invention, the rejuvenating agent is long-lasting, meaning that it is not lost during asphalt manufacturing such as is possible with typical aromatic benchmark rejuvenating agents.

In a particular embodiment of the present invention, the rejuvenation agent is non-toxic and is long-lasting, meaning that it is not lost during asphalt manufacturing such as is possible with typical aromatic benchmark rejuvenating agents.

According to the present invention, the bituminous binder may comprise reclaimed asphalts containing aged binder containing modifiers such as polymers. In these cases, the described chemical balance (between “saturates”, “aromatics”, “resins” and “asphaltenes”) is already challenged in the virgin bitumen and after ageing results in an even bigger challenge. Nevertheless, especially this gets more and more important, as most of the reclaimed asphalts will result from surface courses which contain preferably these modifiers.

The bituminous binder to be rejuvenated in accordance with the present invention can be a bituminous binder derived from a variety of sources, such as virgin bitumen, natural bitumen, and different kinds of aged bituminous binders in need of rejuvenation. For example, the bituminous binder to be rejuvenated is selected from the group consisting of virgin bitumen, natural bitumen, blown bitumen compositions, polymer-containing bitumen compositions, metallocene containing bitumen compositions, and synthetic wax-containing bitumen compositions. The polymer-containing bitumen compositions may be bituminous binders that have been modified with polymers such as styrene-butadiene-styrene (SBS) or ethylene vinyl acetate (EVA).

In one embodiment of the present invention, the bituminous binder comprises reclaimed asphalt.

The bituminous binder to be rejuvenated in accordance with the present invention suitably contains asphaltenes in an amount in the range of from 1 to 40 wt.-%.

In a preferred embodiment of the present invention, the bituminous binder comprises reclaimed asphalt pavement binder, reclaimed asphalt shingle binder, virgin bitumen with a hardness grade of at least 50/70, or a mixture thereof. Optionally, the bituminous binder according to the present invention may comprise reclaimed asphalt pavement binder, reclaimed asphalt shingle binder, virgin bitumen with a hardness grade of at least 50/70, or a mixture thereof in combination with a virgin binder. In this connection it is to be understood that the softness of the bituminous binder comprising virgin bitumen with a hardness grade of at least 50/70 may sufficiently be adjusted using the rejuvenating agents as outlined in the present invention, if desired. In a particular preferred embodiment of the present invention, the bituminous binder comprises reclaimed asphalt pavement binder, reclaimed asphalt shingle binder, or a mixture thereof, optionally in combination with a virgin binder.

In another embodiment of the present invention, the bituminous binder comprises reclaimed asphalt pavement binder from 10 to 100 wt.-%, based on the total weight of the bituminous binder.

In one embodiment of the present invention, the bituminous binder comprises reclaimed asphalt shingle binder from 10 to 100 wt.-%, based on the total weight of the bituminous binder.

In yet another embodiment of the present invention, the bituminous binder comprises a mixture of reclaimed asphalt pavement binder and reclaimed asphalt shingle binder from 10 to 100 wt.-%, based on the total weight of the bituminous binder.

In one embodiment of the present invention, the bituminous binder comprises further additives, preferably wherein the further additives are selected from the group consisting of polymers, waxes, fibers, or mixtures thereof.

In this connection, suitable polymers such as styrene-butadiene-styrene (SBS), styrene-butadiene rubbers, ethylene vinyl acetate (EVA), and rubber may be named.

Suitable waxes such as polyethylene waxes may be named.

Suitable fibers such as cellulose may be named.

Binder compositions according to the present invention have been improved with respect to at least one property, if the measured value of the property in question is getting closer to the ideal value or ideal value range for said property or if the measured value is brought within the ideal range for said property by the addition of a rejuvenating agent in accordance with the present invention, when compared to a corresponding binder composition to which no or a benchmark rejuvenating agent was added. The ideal values are the following:
softness, viscosity, MSCR, elasticity, low-temperature behavior BBR S value and ageing behavior (AI): as low as possible;
loss tangent, low-temperature behavior BBR m value: as high as possible.

In comparison with the typical benchmark rejuvenating agents the rejuvenating agents according to the present invention can in general lower at least one of the properties selected from softening point, viscosity, MSCR elastic recovery, ageing index, and BBR S value. This holds true in systems representing aged bitumen such as bitumen 20/30, but also in actually laboratory aged bitumen samples as well as in bitumen extracted from e.g. RAP or RAS.

In the following, the further aspects of the present invention will be outlined. It is to be understood that unless noted otherwise, all above-described embodiments especially in view of the binder composition, the bituminous binder, and the rejuvenating agent shall also apply for the following aspects.

As indicated above, the present invention further relates in one embodiment to an asphalt composition comprising aggregate and the binder composition as above-defined. In one embodiment, the asphalt composition is an emulsion.

The asphalt composition according to the present invention may comprise the binder composition as above-defined from 2 to 15 wt.-%, preferably from 3 to 10 wt.-%, more preferably from 4 to 7.5 wt.-%, based on the total weight of the asphalt composition.

The asphalt composition according to the present invention may comprise the aggregate from 85 to 98 wt.-%, preferably from 90 to 97 wt.-%, more preferably from 92.5 to 96 wt.-%, based on the total weight of the asphalt composition.

In a preferred embodiment of the present invention, the asphalt composition comprises at least one rejuvenating agent which is selected from the group consisting of alkoxylates; N,N-dialkylamides of aliphatic carboxylic acids; N-alkyl lactames; poly(alkylamines); mono glycidylethers and -esters, di- and tri glycidylethers, diglycidylethers of polymeric alcohols, and mixtures thereof with catalysts; and plasticizers.

As indicated above, the present invention further relates in one embodiment to a paved road surface, road subsurface, runway, driveway, parking lot, road shoulder, bridge, bridge abutment, roofing, bank revetment, or unpaved road comprising the above-defined asphalt composition.

In one embodiment, the present invention relates to a paved road surface, road subsurface, runway, driveway, parking lot, road shoulder, bridge, bridge abutment, roofing, bank revetment, or unpaved road comprising the above-defined asphalt composition, wherein the bituminous binder comprises reclaimed asphalt pavement (RAP) and/or asphalt shingles from roofing (RAS).

As indicated above, the present invention further describes two analytical methods novel for the analysis of the bituminous microstructure, by which the advantage of the here claimed rejuvenating agents over the state of the art is clearly distinguishable. Additionally, the two novel analytical methods are easily feasible.

Hence, one embodiment of the present invention relates to a method for evaluating the efficiency of a rejuvenating agent in a binder composition, wherein the efficiency of the rejuvenating agent is proven via

(i) the loss tangent before or after ageing, obtained from a dynamic shear rheometer (DSR) frequency sweep at a defined temperature, wherein the frequency sweep is measured at a temperature from 0 to 90° C. and wherein an effective rejuvenating agent fulfills inequation (a)

loss tangent[bc]>1.3×loss tangent [bb], (a)

wherein loss tangent[bc] denotes the loss tangent of the binder composition and loss tangent [bb] denotes the bituminous binder and wherein loss tangent[bc] and loss tangent [bb] are evaluated at a frequency from 0.01 to 10 rad/s, preferably at a frequency from 0.01 to 1 rad/s, or

(ii) TD NMR relaxation experiments performed on bitumen samples at a temperature of from −50 to 200° C. and wherein an effective rejuvenating agent fulfills inequation (aa1)

T2e1[bc]>1.3×T2e1[bb] (aa1)

wherein T2e1[bc] denotes the relaxation times that correspond to the individual component of the binder composition and T2e1[bb] denotes the relaxation times that correspond to the individual component of the bituminous binder.

It is to be understood that an efficient rejuvenating agent improves the workability (in particular the viscosity) of the bituminous binder after addition of the rejuvenating agent. A rejuvenating agent is in particular considered being efficient, when the loss tangent and/or the mobile components determined via TD NMR increases after addition of the rejuvenating agent, when compared to the respective value of the untreated bituminous binder (in particular of aged bituminous binder). It is further preferred that the rejuvenating agent should have as less negative impact on the rejuvenated bituminous binder as possible.

Using the loss tangent it can be proven that the rejuvenating agents according to the present invention have a different mode of action as the typical benchmark rejuvenating agents. The effect of the rejuvenating agents in accordance with the present invention on the loss tangent is completely different. Here, a much stronger increase of the loss tangent after having been rejuvenated with the rejuvenating agents in accordance with the present invention can be seen compared to the typical benchmarks. This means that the rejuvenating agents according to the present invention have an impact on the microstructure of the bitumen e.g. by dissolution of the asphaltene aggregates or restructuring of the micelles, and do not simply dilute the binder phase as do most of the benchmarks.

The evaluation methods according to the present invention provide an indication of the working mechanism.

When using the analysis of the loss tangent (tan δ) frequency sweeps are being detected. The loss tangent is the ratio between G″, the viscous contribution, to G′, the elastic contribution, to G*. The higher the ratio, the larger the viscous contribution to the rheological properties, and therefore the higher the mobility of the molecules within the bitumen phase. Especially at low frequencies, at which the measurement itself has a very low impact on the system, one can extract information about the mobility of the bitumen constituents.

In general, the frequency sweep can be measured at a temperature from 0 to 200° C., preferably from 20 to 100° C. According to the present invention, the frequency seep is measured at a temperature from 0 to 90° C., preferably from 20 to 90° C., more preferably from 30 to 90° C., even more preferably from 40 to 80° C., still more preferably from 50 to 70° C., and in particular from 55 to 65° C.

Preferably, the frequency sweep is measured at 60° C. from 0.01 ascending to 100 rad/s at a sheer deformation y of 0.5%. The tan δ is preferably evaluated at a frequency from 0.01 to 10 rad/s, more preferably at a frequency from 0.01 to 1 rad/s, in particular at the lowest frequency.

In a preferred embodiment, inequation (b)

loss tangent[bc]>1.5×loss tangent [bb], (b)

is fulfilled, wherein loss tangent[bc] denotes the loss tangent of the binder composition and loss tangent [bb] denotes the bituminous binder and wherein loss tangent[bc] and loss tangent [bb] are evaluated at a frequency from 0.01 to 10 rad/s.

In a more preferred embodiment, inequation (c)

loss tangent[bc]>2×loss tangent [bb], (c)

is fulfilled, wherein loss tangent[bc] denotes the loss tangent of the binder composition and loss tangent [bb] denotes the bituminous binder and wherein loss tangent[bc] and loss tangent [bb] are evaluated at a frequency from 0.01 to 10 rad/s.

Using the TD NMR analysis it can be proven that the rejuvenating agents according to the present invention have an increased impact on the binder's mobility as do typical benchmark rejuvenating agents. The effect of the rejuvenating agents in accordance with the present invention on the number and type of mobile components is different. Binders having been rejuvenated with the rejuvenating agents in accordance with the present invention have more mobile components as well as components with higher mobility compared to the typical benchmarks. This means that the rejuvenating agents according to the present invention have a different impact on the microstructure of the bitumen.

When using the TD NMR analysis, signal fractions of the individual components with differing mobilities as well as their relaxation times are being detected. The higher the amount of mobile or partially mobile components, and the higher their mobilities are (meaning the longer the corresponding relaxation times of each mobile component) the larger is the viscous contribution to the rheological properties, and therefore the higher the mobility of the molecules within the bitumen phase.

In general, the TDNMR can be measured at a temperature of from −100 to 200° C. According to the present invention, the TDNMR is measured at a temperature of from −50 to 200° C., preferably from 0 to 180° C., more preferably from 20 to 150° C.

In a preferred embodiment, an effective rejuvenating agent fulfills inequation (bb1)

T2e1[bc]>1.5×T2e1[bb] (bb1)

wherein T2e1[bc] denotes the relaxation times that correspond to the individual component of the binder composition and T2e1[bb] denotes the relaxation times that correspond to the individual component of the bituminous binder, each measured at 30° C.

In a preferred embodiment, an effective rejuvenating agent fulfills inequation (aa2)

pe1[bc]>1.05×pe1[bb] (aa2),

more preferably fulfills inequation (bb2)

pe1[bc]>1.1×pe1[bb] (bb2),

wherein pe1[bc] denotes the signal fraction of the individual component scaled in the range from 0 to 1 of the binder composition and pe1[bb] denotes the signal fraction of the individual component scaled in the range from 0 to 1 of the bituminous binder, each measured at 30° C.

In a preferred embodiment, an effective rejuvenating agent fulfills inequation (aa3)

T2g2[bc]>1.05×T2g2[bb] (aa3),

preferably fulfills inequation (bb3)

T2g2[bc]>1.1×T2g2T2g2[bb] (bb3),

wherein T2g2[bc] denotes the relaxation times that correspond to the individual component of the binder composition and T2g2[bb] denotes the relaxation times that correspond to the individual component of the bituminous binder, each measured at 30° C.

In a preferred embodiment, an effective rejuvenating agent fulfills inequation (aa4)

pe1[bc]>1.05×pe1[bb] (aa4),

preferably fulfills inequation (bb4)

pe1[bc]>1.1×pe1[bb] (bb4),

wherein pe1[bc] denotes the signal fraction of the individual component scaled in the range from 0 to 1 of the binder composition and pe1[bb] denotes the signal fraction of the individual component scaled in the range from 0 to 1 of the bituminous binder, each measured at 80° C.

In a preferred embodiment, an effective rejuvenating agent fulfills inequation (aa5)

T2e2[bc]>1.2×T2e2[bb] (aa5),

preferably fulfills inequation (bb5)

T2e2[bc]>1.3×T2e2[bb] (bb5),

wherein T2e2[bc] denotes the relaxation times that correspond to the individual component of the binder composition and T2e2[bb] denotes the relaxation times that correspond to the individual component of the bituminous binder, each measured at 80° C.

In a preferred embodiment, an effective rejuvenating agent fulfills inequation (aa6)

T2e2[bc]>1.2×T2e2[bb] (aa6),

preferably fulfills inequation (bb6)

T2e2[bc]>1.3×T2e2[bb] (bb6),

wherein T2e2[bc] denotes the relaxation times that correspond to the individual component of the binder composition and T2e2[bb] denotes the relaxation times that correspond to the individual component of the bituminous binder, each measured at 140° C.

In a preferred embodiment, an effective rejuvenating agent fulfills inequation (aa7)

T2e3[bc]>1.15×T2e3[bb] (aa7),

preferably fulfills inequation (bb7)

T2e3[bc]>1.25×T2e3[bb] (bb7),

wherein T2e7[bc] denotes the relaxation times that correspond to the individual component of the binder composition and T2e3[bb] denotes the relaxation times that correspond to the individual component of the bituminous binder, each measured at 140° C.

Preferably, effective rejuvenating agent fulfills at least two, more preferably at least three, still more preferably at least four, and in particular at least five inequations selected from the group consisting of (aa1), (aa2), (aa3), (aa4), (aa5), (aa6), and (aa7), are fulfilled.

Preferably, effective rejuvenating agent fulfills at least two, more preferably at least three, still more preferably at least four, and in particular at least five inequations selected from the group consisting of (bb1), (bb2), (bb3), (bb4), (bb5), (bb6), and (bb7), are fulfilled.

For further details regarding the TD NMR technique it is referred to the experimental section below.

As indicated above, the present invention further relates in one embodiment to the use of a rejuvenating agent comprising at least an asphaltene dispersant, an asphaltene reactivator, a maltene reactivator, or mixtures thereof for recycling Reclaimed Asphalt Pavement (RAP) and/or asphalt shingles from roofing (RAS).

In a preferred embodiment of the present invention, the rejuvenating agent is selected from the group consisting of alkoxylates; N,N-dialkylamides of aliphatic carboxylic acids; N-alkyl lactames; poly(alkylamines); mono glycidylethers and -esters, di- and tri glycidylethers, diglycidylethers of polymeric alcohols, and mixtures thereof with catalysts; and plasticizers.

In a preferred embodiment of the present invention, the rejuvenating agent is selected from the group consisting of alkoxylates having the structure of formula (1)

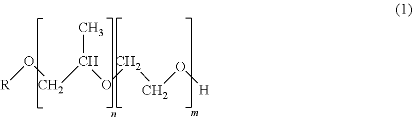

wherein

R is C₁₀-alky or C₁₃-alkyl, preferably 2-propyl heptyl or isotridecyl,

n is 0 to 6,

m is 0 to 8, and wherein

n+m ≥5, poly(bis aminopropyl amine), N-dodecyl pyrrolidone, polypropyleneglycol bis(glycidyl)ether, and diisononyl cyclohexane-1,2-dicarboxylate.

The invention further relates to the following items:

1. A binder composition comprising
(a) a bituminous binder; and
(b) a rejuvenating agent from 0.05 to 20 wt.-%, based on the total amount of the binder composition,
wherein the rejuvenating agent comprises at least an asphaltene dispersant, an asphaltene reactivator, a maltene reactivator, or mixtures thereof.
2. The binder composition according to item 1, wherein the rejuvenating agent introduces a microstructural change of the bitumen micellar structure, preferably wherein the loss tangent of the binder composition is increased compared to the loss tangent of the bituminous binder and/or
wherein the amount of the mobile components of the binder composition and/or their respective mobility as per TD NMR is increased compared to the amount of the mobile components of the bituminous binder and/or their respective mobility.
3. The binder composition according to item 1 or 2,
wherein the rejuvenating agent comprises
(i) the asphaltene dispersant from 1 to 100 wt. %, based on the total amount of the rejuvenating agent;
(ii) the asphaltene reactivator from 1 to 100 wt. %, based on the total amount of the rejuvenating agent;
(iii) the maltene reactivator from 1 to 100 wt. %, based on the total amount of the rejuvenating agent; or
(iv) a mixture consisting of at least two of the components from (i) to (iii) from 1 to 100 wt. % based on the total amount of the rejuvenating agent.
4. The binder composition according to any one of items 1 to 3, wherein the bituminous binder comprises reclaimed asphalt pavement binder, reclaimed asphalt shingle binder, or a mixture thereof, optionally in combination with a virgin binder.
5. The binder composition according to any one of items 1 to 4, wherein the binder composition comprises
an asphaltene dispersant, which is selected from the group consisting of alkoxylates, N,N-dialkylamides of aliphatic carboxylic acids, N-alkyl lactames, and poly(alkylamines), preferably wherein the asphaltene dispersant is selected from the group consisting of alkoxylates having the structure of formula (1)

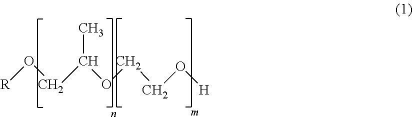

wherein

R is H, C₁-C₂₂-alkyl, C₂-C₂₂-alkenyl, phenyl, or alkyl phenyl,

n is 0 to 20,

m is 0 to 20, and wherein n+m≥1;

N,N-dialkylamides of aliphatic carboxylic acids having the structure of formula (2)

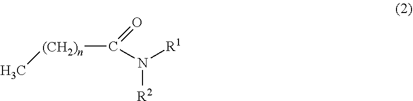

wherein

n is 3 to 16, wherein the carbon atom of at least one “CH₂” moiety may be further substituted with at least one C₁-C₅-alkyl and wherein at least two carbon atoms of two adjacent “CH₂” moieties may form a double bond,

R¹ is C₁-C₄-alkyl, and
R² is C₁-C₄-alkyl;

N-alkyl lactames having the structure of formula (3)

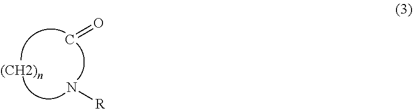

wherein

n is 3 to 11, wherein the carbon atom of at least one “CH₂” moiety may be further substituted with at least one C₁-C₃-alkyl, and

R is C₁-C₂₂-alkyl or C₂-C₂₂-alkenyl; or

poly(alkylamines) having the structure of formula (4)

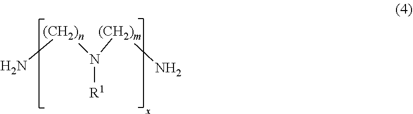

wherein

n is 1 to 6, wherein at least two carbon atoms of two adjacent “CH₂” moieties may form a double bond,

m is 1 to 6, wherein at least two carbon atoms of two adjacent “CH₂” moieties may form a double bond,

x is 4 to 50, and

R¹ is C₁-C₄-alkyl,

wherein these poly(alkylamines) may further be derived at the terminal amine moieties with C₁-C₄-alkyl, fatty acids or alkoxylated;
and/or an asphaltene reactivator, which is selected from the group consisting of mono glycidylether and -ester, di- and tri glycidylether, diglycidylether of polymeric alcohol, and mixtures thereof with catalysts such as N,N-dimethyl benzylamine; preferably wherein mono glycidylether and -ester, di- and tri glycidylether, diglycidylether of polymeric alcohol have the structure of formula (5a), (5b), (5c), and 5(d)

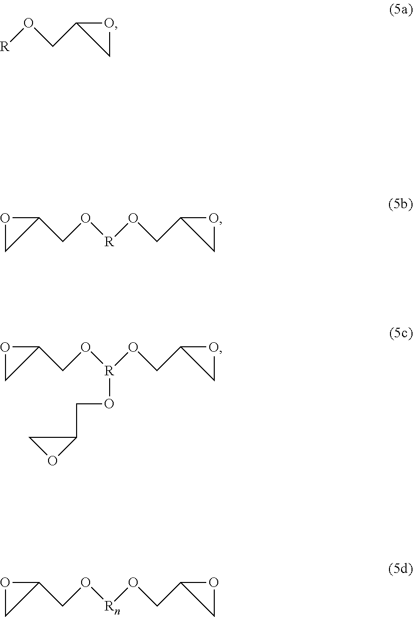

wherein

for formula (5a)

R is C₁-C₂₀-alkoxy, C₂-C₂₀-alkenyloxy, phenoxy, or C₁-C₂₀-carboxyalkyl, wherein the phenoxy may be further substituted with at least one C₁-C₁₅-alkyl;

for formula (5b)

R is straight C₅-C₂₀-alkylene which may be further substituted with at least one C₁-C₅-alkyl or C₁-C₄-alkylene, which is further substituted with at least one C₁-C₁₀-alkyl and/or at least one phenyl;

for formula (5c)

R is C₁-C₅-alkylene; and

for formula (5d)

Rₙ has the formulae (6a), (6b), or (6c)

(—CH₂CH₂O—)ₙ (6a),

wherein n is 3 to 20,

(—CH₂CH(CH₃)O—)ₙ (6b),

wherein n is 3 to 18, or

(—CH₂CH₂CH₂CH₂O—)ₙ (6c)

wherein n is 3 to 18;
and/or a maltene reactivator, which is a plasticizer, preferably having the formula (7a), (7b), (7c), (7d), or (7e),

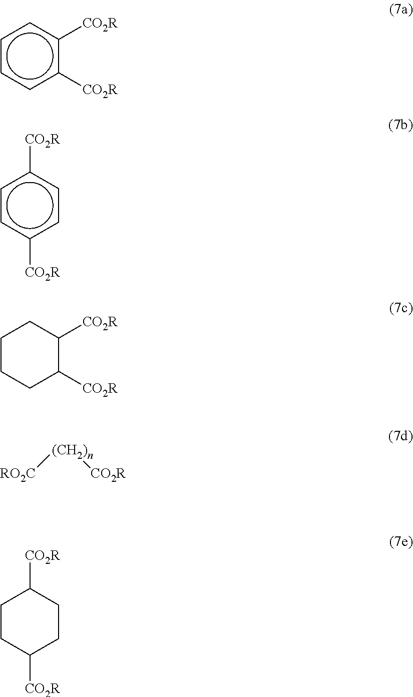

wherein

for formula (7a)

R is C₄-C₁₄-alkyl or C₄-C₁₄-alkenyl;

for formula (7b)

R is C₄-C₁₄-alkyl or C₄-C₁₄-alkenyl;

for formula (7c)

R is C₄-C₁₄-alkyl or C₄-C₁₄-alkenyl;

for formula (7d)

R is C₄-C₁₄-alkyl or C₄-C₁₄-alkenyl;

for formula (7e)

R is C₄-C₁₄-alkyl or C₄-C₁₄-alkenyl, and

n is 4 to 10, wherein at least two carbon atoms of two adjacent “CH₂” moieties may form a double bond.
6. The binder composition according to any one of items 1 to 5, wherein the asphaltene dispersant is selected from the group consisting of alkoxylates, N,N-dialkylamides of aliphatic carboxylic acids, N-alkyl lactames, and poly(alkylamines), preferably wherein the asphaltene dispersant is selected from the group consisting of alkoxylates having the structure of formula (1)

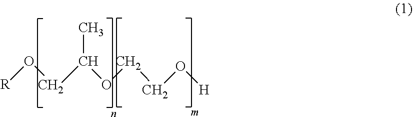

wherein

R is H, C₁-C₂₂-alkyl, C₂-C₂₂-alkenyl, phenyl, or alkyl phenyl,

n is 0 to 20,

m is 0 to 20, and wherein

n+m≥1;

N,N-dialkylamides of aliphatic carboxylic acids having the structure of formula (2)

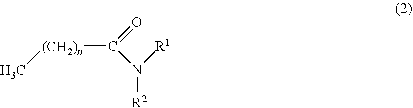

wherein

n is 3 to 16, wherein the carbon atom of at least one “CH₂” moiety may be further substituted with at least one C₁-C₅-alkyl and wherein at least two carbon atoms of two adjacent “CH₂” moieties may form a double bond,

R¹ is C₁-C₄-alkyl, and

R² is C₁-C₄-alkyl;

N-alkyl lactames having the structure of formula (3)

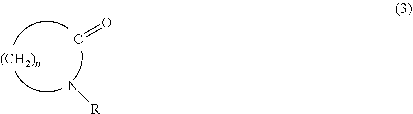

wherein

n is 3 to 11, wherein the carbon atom of at least one “CH₂” moiety may be further substituted with at least one C₁-C₃-alkyl, and

R is C₁-C₂₂-alkyl or C₂-C₂₂-alkenyl; or

poly(alkylamines) having the structure of formula (4)

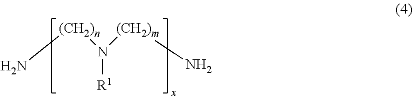

wherein

n is 1 to 6, wherein at least two carbon atoms of two adjacent “CH₂” moieties may form a double bond,

m is 1 to 6, wherein at least two carbon atoms of two adjacent “CH₂” moieties may form a double bond,

x is 4 to 50, and

R¹ is C₁-C₄-alkyl,

wherein these poly(alkylamines) may further be derived at the terminal amine moieties with C₁-C₄-alkyl, fatty acids or alkoxylated.
7. The binder composition according to any one of items 1 to 6, wherein the asphaltene reactivator is selected from the group consisting of mono glycidylether and -ester, di- and tri glycidylether, diglycidylethers of polymeric alcohol, and mixtures thereof with catalysts; preferably wherein mono glycidylether and -ester, di- and tri glycidylether, diglycidylethers of polymeric alcohol have the structure of formula (5a), (5b), (5c), and 5(d)

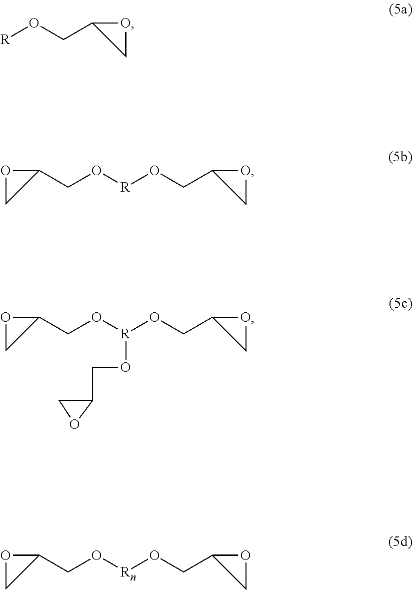

wherein

for formula (5a)

R is C₁-C₂₀-alkoxy, C₂-C₂₀-alkenyloxy, phenoxy, or C₁-C₂₀-carboxyalkyl, wherein the phenoxy may be further substituted with at least one C₁-C₁₅-alkyl;

for formula (5b)

R is straight C₅-C₂₀-alkylene which may be further substituted with at least one C₁-C₅-alkyl or C₁-C₄-alkylene, which is further substituted with at least one C₁-C₁₀-alkyl and/or at least one phenyl;

for formula (5c)

R is C₁-C₅-alkylene; and

for formula (5d)

Rₙ has the formulae (6a), (6b), or (6c)

(—CH₂CH₂O—)ₙ (6a),

wherein n is 3 to 20,

(—CH₂CH(CH₃)O—)ₙ (6b),

wherein n is 3 to 18, or

(—CH₂CH₂CH₂CH₂O—)ₙ (6c)

wherein n is 3 to 18;
more preferably wherein the asphaltene reactivator is selected from the group consisting of polyethyleneglycol bis(glycidyl)ether, polypropyleneglycol bis(glycidyl)ether, neopentylglycol bis glycidylether, 2-methyl-2-phenyl-1,3-propandiol bis glycidylether, 2-ethylhexyl glycidyl ether, as well as mixtures of these compounds with catalysts; even more preferably wherein the asphaltene reactivator is polypropyleneglycol bis(glycidyl)ether.
8. The binder composition according to any one of items 1 to 7, wherein the maltene reactivator is a plasticizer, preferably wherein the plasticizer has the formula (7a), (7b), (7c), (7d), or (7e),

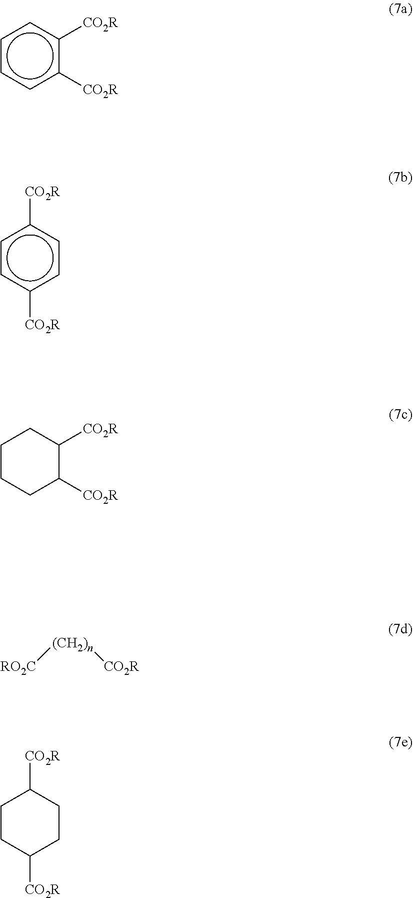

wherein

for formula (7a)

R is C₄-C₁₄-alkyl or C₄-C₁₄-alkenyl;

for formula (7b)

R is C₄-C₁₄-alkyl or C₄-C₁₄-alkenyl;

for formula (7c)

R is C₄-C₁₄-alkyl or C₄-C₁₄-alkenyl;

for formula (7d)

R is C₄-C₁₄-alkyl or C₄-C₁₄-alkenyl;

for formula (7e)

R is C₄-C₁₄-alkyl or C₄-C₁₄-alkenyl, and

n is 4 to 10, wherein at least two carbon atoms of two adjacent “CH₂” moieties may form a double bond, more preferably wherein the maltene reactivator is selected from the group consisting of diisononyl phthalate or diisononyl cyclohexane-1,2-dicarboxylate, more preferably wherein the maltene reactivator is diisononyl cyclohexane-1,2-dicarboxylate.
9. The binder composition according to any one of items 1 to 8, wherein the bituminous binder comprises reclaimed asphalt pavement and/or reclaimed asphalt shingles binder from 10 to 100 wt.-%, based on the total weight of the bituminous binder.
10. The binder composition according to any one of items 1 to 9, wherein the bituminous binder comprises further additives, preferably wherein the further additives are selected from the group consisting of polymers, waxes, fibers, or mixtures thereof.
11. An asphalt composition comprising aggregate and the binder composition according to any one of items 1 to 10.
12. A paved road surface, road subsurface, runway, driveway, parking lot, road shoulder, bridge, bridge abutment, roofing, bank revetment, or unpaved road comprising the asphalt composition according to item 11.
13. A method for evaluating the efficiency of a rejuvenating agent in a binder composition, wherein the efficiency of the rejuvenating agent is proven via
(i) the loss tangent before or after ageing, obtained from a dynamic shear rheometer (DSR) frequency sweep at a defined temperature, or
(ii) TD NMR relaxation experiments performed on bitumen samples at a defined temperature.
14. Use of a rejuvenating agent comprising at least an asphaltene dispersant, an asphaltene reactivator, a maltene reactivator, or mixtures thereof for recycling Reclaimed Asphalt Pavement (RAP) and/or asphalt shingles from roofing (RAS).

The invention will now be further illustrated by the following Examples, which do not limit the invention in any way.

### EXAMPLES

### Example 1: Softness and Viscoelastic Properties of Rejuvenated Bitumen 20/30

A large variety of chemically different structures were evaluated towards their ability to rejuvenate bitumen 20/30, a bitumen type known to resemble to a good extent aged bitumen (e.g. asphaltene content, rheological behavior). A selection of the tested substances is listed in Table 1. To test the different substances, 100 g of bitumen 20/30 was rejuvenated with 5% of the respective compound at 180° C. for 30 minutes under stirring. The rejuvenated bitumen (i.e. binder composition) samples were subsequently analyzed for their softening point (SP), viscosity at 135° C. and percentage elastic recovery from the MSCR test. All tested samples were compared to the pure 20/30 bitumen that was also stirred for 30 minutes at 180° C., however in the absence of any additive.

If the softening point, viscosity and elastic recovery increased, did not change or only slightly decreased, the tested substance was judged as not or only slightly rejuvenating. If the softening point decreased strongly (approximately by 10° C.) the viscosity decreased below 1000 mPas and the MSCR elastic response decreased below e.g. 10% for 0.1 kPa, or if at least most of these criteria were fulfilled, the tested substance had a very good capability of rejuvenating bitumen 20/30.

From Table 1 it can be seen that not all of the tested samples could rejuvenate bitumen 20/30. Without being bound to any theory, it is believed that the sample of Glissopal® 2300 (Ex. 1.2) itself was too viscous or too elastic to achieve the desired effect in bitumen 20/30. From the Koresin® Soft (Ex. 1.3) and Lignoboost® (Ex. 1.5) samples it is believed that due to their high molecular weights no rejuvenation could be observed. Dodecylbenzene sulfonic acid (Ex. 1.8), hardened the bitumen, which is most probably due to its high polarity.

Many of the tested samples however were able to rejuvenate bitumen 20/30. The samples Palatinol® DINP or Hexamoll® DINCH could soften bitumen 20/30 quite well, and without being bound to any theory it is believed that this is because they successfully replenish the maltene phase due to their maltene similar chemical structures.

In another example, N-dodecyl pyrrolidone, from which it is believed that it disrupts the asphaltene stacks, or poly(bis aminopropyl amine), from which it is believed that it disperses the asphaltene stacks better within the maltenes, worked very well. A large class of surfactants (Lutensol® T03, Lutensol® TO8, Lutensol® TO15, Lutensol® XP70, Lutensol® XL60, Lutensol® T05, Agnique AMD 12@, Triton™ X-100) were also found to be very effective, and here it is also believed that they disrupt the asphaltene stacks successfully. Not all tested surfactants could rejuvenate bitumen 20/30 in all tested parameters, such as Pluronic® PE 6400, Tetronic® 90R4, or Disponil® FEP 3830 PA, probably as a result of their higher polarities or too high molecular weights.

Another class of compounds (dodecenyl succinic acid anhydride, polypropylenglycol bis glycidylether, neopentylglycol bis glycidylether, 2-methyl-2-phenyl-1,3-propandiol bis glycidylether), of which it is believed that they can react with polar functions of the asphaltenes and/or resins (e.g. COOH or OH groups) thereby reintroducing solubility to the asphaltenes, which was previously lost during ageing, was also found to be very well rejuvenating. Only polyethylenglycol bis glycidylether just slightly rejuvenated the system, maybe due to its higher polarity and/or rigidity compared to polypropylenglycol bis glycidylether.

Particularly preferred rejuvenating agents were determined to have an (eco-)toxicological profile, which should not be aquatoxic or harmful to the human health under the conditions of the asphalt mixing process (e.g. toxicity upon inhaling). As a result, from the shown examples the samples Hexamoll® DINCH (Ex. 1.7), poly(bis aminopropyl amine) (Ex. 1.11), Lutensol® XL60 (Ex. 1.17), N-dodecyl pyrrolidone (Ex. 1.9) and polypropylenglycol bis glycidylether (Ex. 1.24) were determined as the most preferred candidates (subsequently called preferred candidates). These chemical compounds were found to be well rejuvenating and can preferably be used as rejuvenating agents at the asphalt mixing plant.

TABLE 1
The following abbreviations are used: Suppl.—supplier; SP—softening point;
Rec.—recovery; tox—toxicology/eco toxicology

| | | | | | MSCR % Rec. | | | |
|---|---|---|---|---|---|---|---|---|
| | | | SP | η (135° C.) | (0.1 | (1.6 | (3.2 | |
| Ex. | Product | Suppl. | [° C.] | [mPas] | kPa) | kPa) | kPa) | tox |
| 1.1 | Bitumen 20/30 | TOTAL | 60.0 | 1,750 | 21 | 17 | 12 | |
| | (asphaltene | Chimie | | | | | | |
| | rich bitumen) | | | | | | | |
| 1.2 | Glissopal ® | BASF | 61.0 | 1,650 | 25 | 20 | 14 | — |
| | 2300 | | | | | | | |
| 1.3 | Koresin ® Soft | BASF | 63.0 | 1,950 | 24 | 21 | 16 | — |
| 1.4 | Keroflux ® | BASF | 55.0 | 1,150 | 15 | 8 | 4 | Aquatox. |
| | 6030 | | | | | | | |
| 1.5 | Lignoboost ® | BASF | 62.0 | 2,400 | 24 | 21 | 16 | — |
| 1.6 | Palatinol ® | BASF | 52.0 | 950 | 9 | 3 | 1 | — |
| | DINP | | | | | | | |
| 1.7 | Hexamoll ® | BASF | 52.0 | 950 | 10 | 4 | 1 | — |
| | DINCH | | | | | | | |
| 1.8 | Dodecylbenzene | | 64.0 | 2,100 | 27 | 25 | 21 | Harmful |
| | sulfonic | | | | | | | (Skin, |
| | acid | | | | | | | Eye) |
| 1.9 | N-Dodecyl | | 47.0 | 800 | 4 | 1 | 0 | Harmful |
| | pyrrolidone | | | | | | | (Skin, |
| | | | | | | | | Eye); |
| | | | | | | | | Aquatox. |
| 1.10 | Agnique AMD | BASF | 47.0 | 750 | 5 | 1 | 0 | Irritating; |
| | 12 ® | | | | | | | Aquatox. |
| 1.11 | Poly(bis | BASF | 51.0 | 1,000 | 8 | 3 | 1 | |
| | aminopropyl | | | | | | | |
| | amine); m.w. | | | | | | | |
| | 2000 g/mol | | | | | | | |
| 1.12 | para-tert.- | | 51.0 | 1,000 | 9 | 3 | 1 | Harmful; |
| | Butyl phenol, | | | | | | | Irritating; |
| | ethoxylate | | | | | | | Aquatox. |
| | (Triton X-100) | | | | | | | |
| 1.13 | Lutensol ® TO3 | BASF | 48.0 | 850 | 7 | 1 | 0 | Irritating |
| | | | | | | | | (Eye); |
| | | | | | | | | Aquatox. |
| 1.14 | Lutensol ® TO8 | BASF | 49.0 | 900 | 8 | 2 | 0 | irritating |
| | | | | | | | | (Eye) |
| 1.15 | Lutensol ® | BASF | 51.5 | 900 | 12 | 5 | 2 | Irritating |
| | TO15 | | | | | | | (Eye); |
| | | | | | | | | Harmful |
| | | | | | | | | (Swallowed) |
| 1.16 | Lutensol ® | BASF | 49.5 | 900 | 8 | 2 | 0 | Irritating |
| | XP70 | | | | | | | (Eye); |
| | | | | | | | | Harmful |
| | | | | | | | | (Swallowed) |
| 1.17 | Lutensol ® | BASF | 50.0 | 850 | 7 | 2 | 0 | Irritating |
| | XL60 | | | | | | | (Eye); |
| | | | | | | | | Harmful |
| | | | | | | | | (Swallowed) |
| 1.18 | Pluronic ® PE | BASF | 59.0 | 1,500 | 29 | 22 | 14 | — |
| | 6400 | | | | | | | |
| 1.19 | Lutensol ® TO5 | BASF | 48.0 | 850 | 7 | 1 | 0 | Irritating |
| | | | | | | | | (Eye); |
| | | | | | | | | Aquatox. |
| 1.20 | Tetronic ® | BASF | 60.0 | 1,850 | 31 | 23 | 14 | — |
| | 90R4 | | | | | | | |
| 1.21 | Disponil ® FEP | BASF | 53.0 | 1,450 | 18 | 13 | 8 | Irritating |
| | 3830 PA | | | | | | | (Eye; |
| | | | | | | | | Skin); |
| | | | | | | | | Aquatox. |
| 1.22 | Dodecenyl | | 51.0 | 950 | 10 | 4 | 2 | Irritating |
| | succinic acid | | | | | | | (Eye; |
| | anhydride | | | | | | | Skin) |
| 1.23 | Polyethylenglycol | | 57.0 | 1,000 | 16 | 10 | 5 | — |
| | bis | | | | | | | |
| | glycidylether | | | | | | | |
| | (PPG-BGE); | | | | | | | |
| | m.w. 380 | | | | | | | |
| | g/mol | | | | | | | |
| 1.24 | Polypropylenglycol | | 50.0 | 900 | 8 | 2 | 1 | — |
| | bis | | | | | | | |
| | glycidylether; | | | | | | | |
| | m.w. 380 | | | | | | | |
| | g/mol | | | | | | | |
| 1.25 | Neopentylglycol | | 52.0 | 1,050 | 11 | 5 | 2 | Irritating |
| | bis | | | | | | | (Skin) |
| | glycidylether | | | | | | | |
| 1.26 | 2-Methyl-2- | BASF | 52.0 | 900 | 8 | 3 | 1 | — |
| | phenyl-1,3- | | | | | | | |
| | propandiol bis | | | | | | | |
| | glycidylether | | | | | | | |

### Comparative Examples (Comp.)

To be able to evaluate the selected candidates in the context of existing benchmarks, a benchmark study was performed in a similar way as was done for Example 1. The results of the benchmark study can be seen in Table 2. All of the benchmarks except for product 1 were able to reduce the softening point, with notable differences between the different products. None of the products were able to lower the softening point to 50° C. or below, as could most of the here claimed preferred candidates. All of the samples could lower the viscosity at 135° C., again with noticeable differences between the different benchmarks, and only three of them were able to decrease it to 1,000 mPas or lower. All except product 1 could lower the elastic recovery during the MSCR test. Especially the product Rheofalt® HP-AM (purchased from; Ventraco Comp. 1.3) could lower the elastic recovery the most, which is why in combination with its ability to lower the softening point and viscosity, it was believed that it is the best performing benchmark under the tested samples. However, compared to the preferred candidates (from Example 1) it does not perform as well.

TABLE 2
The following abbreviations are used:
SP—softening point; Rec.—recovery;

| | | | | η(135° | MSCR % Rec. | | |
|---|---|---|---|---|---|---|---|
| | | | SP | C.) | (0.1 | (1.6 | (3.2 |
| Comp. | product | product code | [° C.] | [mPas] | kPa) | kPa) | kPa) |
| 1.1 | Bitumen | Bitumen | 60.0 | 1,750 | 21 | 17 | 12 |
| | 20/30 | 20/30 | | | | | |
| 1.2 | | product 1 | 66.0 | 1,350 | 36 | 25 | 13 |
| 1.3 | RheoFalt ® | RheoFalt ® | 52.0 | 1,000 | 9 | 4 | 1 |
| | HP-AM | HP-AM | | | | | |
| 1.4 | | product 2 | 51.0 | 1,050 | 12 | 5 | 2 |
| 1.5 | | product 3 | 52.5 | 950 | 12 | 5 | 2 |
| 1.6 | | product 4 | 51.5 | 950 | 11 | 4 | 2 |
| 1.7 | | product 5 | 54.0 | 1,100 | 13 | 8 | 3 |
| 1.8 | | product 6 | 56.0 | 1,200 | 14 | 9 | 4 |

### Example 2: Softness & Viscoelastic Properties of Rejuvenated Aged Bitumen

As the bitumen 20/30 that is used in Example 1 is only a model system and not an actually aged bitumen, it is crucial to verify the performance of the selected candidates in actually aged bitumen. Therefore, the preferred candidates were tested in three different aged bitumen samples: two 50/70 bitumen types from two different refineries that were laboratory aged (RTFOT+PAV) as well as one reclaimed asphalt pavement sample that was composed of extracted bitumen from roads.

The three different bitumen samples were rejuvenated and analyzed in the same way as was done in Example 1. The preferred candidates were every time benchmarked against the product RheoFalt® HP-AM (Comp. 1.3) and also to the not rejuvenated bitumen. The results can be seen in Table 3. It can be seen that, independent of the bitumen type used, may it be 20/30 or the three aged samples, the preferred candidates performed very well. This is very important as different asphalt plants use largely varying bitumen qualities, and well-functioning rejuvenating agents have to work throughout a large spectrum of different bitumen compositions.

TABLE 3
The following abbreviations are used: Suppl.—supplier; SP—softening point;
Rec.—recovery; * The Bitumen extracted from RAP was extracted using
trichloroethylene according to DIN EN 12697-1.

| | | | | η(135° C.) | MSCR % Rec. | | |
|---|---|---|---|---|---|---|---|
| Ex. | product | Suppl. | SP [° C.] | [mPas] | (0.1 kPa) | (1.6 kPa) | (3.2 kPa) |
| 2.1 | Bitumen 50/70 | BP | 50.9 | 550 | 3 | 1 | 0 |
| 2.2 | Bitumen 50/70 | BP | 66.0 | 1,800 | 26 | 25 | 22 |
| | (aged via RTFOT | | | | | | |
| | & PAV) | | | | | | |
| 2.3 | Hexamoll ® DINCH | BASF | 56.5 | 1,000 | 14 | 10 | 5 |
| 2.4 | N-Dodecyl | | 51.0 | 950 | 5 | 2 | 0 |
| | pyrrolidone | | | | | | |
| 2.5 | Poly(bis | BASF | 58.0 | 700 | 11 | 8 | 5 |
| | aminopropyl | | | | | | |
| | amine); m.w. 2000 | | | | | | |
| | g/mol | | | | | | |
| 2.6 | Lutensol ® XL60 | BASF | 53.0 | 750 | 7 | 3 | 1 |
| 2.7 | Polypropylenglycol | | 54.0 | 800 | 7 | 3 | 1 |
| | bis glycidylether; | | | | | | |
| | m.w. 380 g/mol | | | | | | |
| 2.8 | RheoFalt ® HP-AM | VENTRACO | 56.5 | 1,050 | 11 | 7 | 4 |
| 2.9 | Bitumen 50/70 | PCK | 49.5 | 550 | 1 | 0 | 0 |
| | | Schwedt | | | | | |
| 2.10 | Bitumen 50/70 | PCK | 64.0 | 3,150 | 39 | 38 | 37 |
| | (aged via RTFOT | Schwedt | | | | | |
| | & PAV) | | | | | | |
| 2.11 | Hexamoll ® DINCH | BASF | 56.0 | 1,000 | 11 | 7 | 3 |
| 2.12 | N-Dodecyl | | 50.0 | 700 | 5 | 1 | 0 |
| | pyrrolidone | | | | | | |
| 2.13 | Poly(bis | BASF | 58.5 | 1,200 | 15 | 9 | 5 |
| | aminopropyl | | | | | | |
| | amine); m.w. 2000 | | | | | | |
| | g/mol | | | | | | |
| 2.14 | Lutensol ® XL60 | BASF | 52.0 | 750 | 4 | 1 | 0 |
| 2.15 | Polypropylenglycol | | 52.5 | 800 | 5 | 1 | 0 |
| | bis glycidylether; | | | | | | |
| | m.w. 380 g/mol | | | | | | |
| 2.16 | RheoFalt ® HP-AM | VENTRACO | 56.5 | 960 | 8 | 5 | 3 |
| 2.17 | Bitumen extracted | — | 67.0 | 2,000 | 27 | 26 | 23 |
| | from RAP* | | | | | | |
| 2.18 | Hexamoll ® DINCH | BASF | 59.0 | 1,200 | 16 | 12 | 7 |
| 2.19 | N-Dodecyl | | 53.0 | 850 | 7 | 3 | 1 |
| | pyrrolidone | | | | | | |
| 2.20 | Poly(bis | BASF | 61.0 | 1,550 | 16 | 14 | 10 |
| | aminopropyl | | | | | | |
| | amine); m.w. 2000 | | | | | | |
| | g/mol | | | | | | |
| 2.21 | Lutensol ® XL60 | BASF | 55.5 | 1,000 | 10 | 6 | 3 |
| 2.22 | Polypropylenglycol | | 57.0 | 1,100 | 10 | 6 | 3 |
| | bis glycidylether; | | | | | | |
| | m.w. 380 g/mol | | | | | | |
| 2.23 | RheoFalt ® HP-AM | VENTRACO | 57.5 | 1,150 | 11 | 8 | 5 |

### Example 3: Low Temperature Performance (BBR)

Examples 1-2 explained the performance of the different rejuvenating agents on the mid- or high temperature range. However, aged bitumen is also known to have a drastically reduced low-temperature performance, such as increased brittleness. Excellent rejuvenating agents therefore also must improve the low-temperature properties of bitumen.

Different bitumen samples were rejuvenated as in Example 1, and the BBR values S (flexural creep stiffness) and m (creep recovery) were evaluated at −16° C. The results were compared to the not rejuvenated bitumen sample as well as to the bitumen rejuvenated with the benchmark RheoFalt® HP-AM (Comp. 1.3).

In general, all the tested samples had a strong capability of decreasing the stiffness of the bitumen samples at −16° C. All the tested additives made the samples more flexible compared to bitumen 50/70 which is more than sufficient. It can be seen that from the samples tested in bitumen 20/30 the benchmark RheoFalt® HP-AM (Comp. 1.3) had the lowest performance, showing that the preferred candidates according to the present invention had the stronger impact.

TABLE 4

| | | | S-value | |
|---|---|---|---|---|
| Ex. | product | supplier | [MPa] | m-value |
| 3.1 | Bitumen 20/30 | TOTAL | 220 | 0.33 |
| | | Chimie | | |
| 3.2 | Hexamoll ® DINCH | BASF | 90 | 0.41 |
| 3.3 | N-Dodecyl pyrrolidone | | 90 | 0.44 |
| 3.4 | Poly(bis aminopropyl amine); | BASF | 140 | 0.40 |
| | m.w. 2000 g/mol | | | |
| 3.5 | Lutensol ® XL60 | BASF | 85 | 0.45 |
| 3.6 | Polypropylenglycol bis | | 105 | 0.43 |
| | glycidylether; m.w. 380 g/mol | | | |
| 3.7 | RheoFalt ® HP-AM | VENTRACO | 150 | 0.39 |
| 3.8 | Bitumen 50/70 | BP | 180 | 0.39 |
| 3.9 | Bitumen 50/70 (aged via | BP | 230 | 0.28 |
| | RTFOT & PAV) | | | |
| 3.11 | N-Dodecyl pyrrolidone | | 90 | 0.43 |
| 3.12 | Poly(bis aminopropyl amine); | BASF | 175 | 0.33 |
| | m.w. 2000 g/mol | | | |
| 3.13 | Lutensol ® XL60 | BASF | 130 | 0.38 |

### Example 4: Loss Tangent, Tan δ, of Rejuvenated Bitumen Samples

Examples 1 to 3 demonstrated well the ability of the rejuvenating agents according to the present invention and in particular of the preferred candidates according to the present invention to rejuvenate bitumen, independent of the bitumen type. In addition, it could be shown that additives according to the present invention perform most of the times better than the common benchmarks according to the standard testing techniques for the low, mid and high temperature range. What cannot be extracted from these measurements however is an indication of the working mechanism. To do so, the analysis of the loss tangent (tan δ), e.g. from frequency sweeps, is better suited. The loss tangent is the ratio between G″, the viscous contribution, to G′, the elastic contribution, to G*. The higher the ratio, the larger the viscous contribution to the rheological properties, and therefore the higher the mobility of the molecules within the bitumen phase. Especially at low frequencies, at which the measurement itself has a very low impact on the system, meaning selecting the measurement conditions to characterize the bitumen within the linear viscoelastic region (LVE), one can extract information about the mobility of the bitumen constituents.

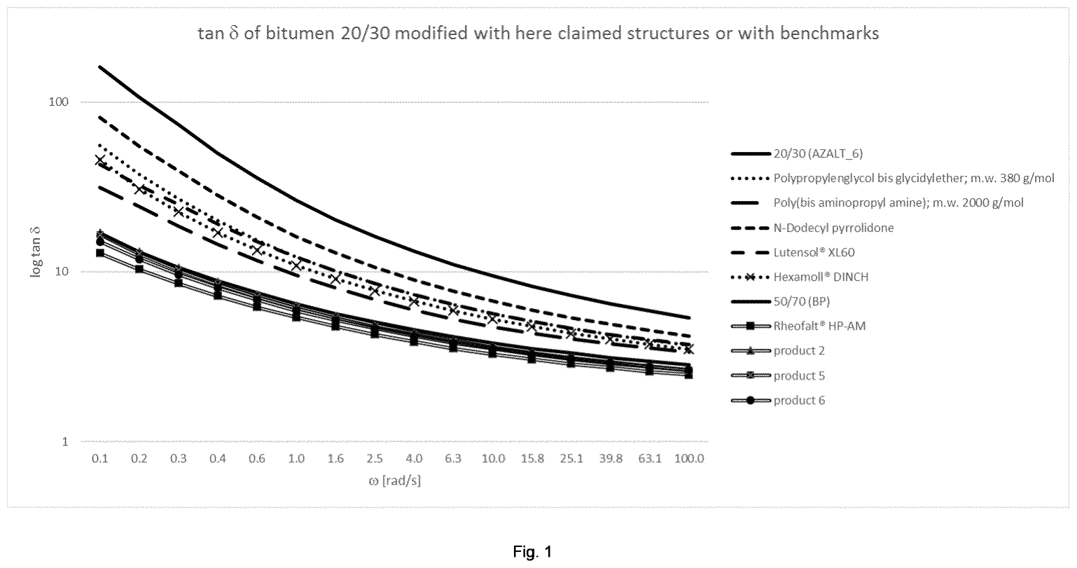

Different bitumen types were rejuvenated with the preferred candidates according to Example 1. Then, the frequency sweep was measured at 60° C. from 0.01 ascending to 100 rad/s at a sheer deformation y of 0.5%. This temperature was chosen as it is a temperature at which the viscous contribution is not yet too high and at which elastic contributions are still strongly determining the rheological response. The tan δ was then evaluated for each sample at the lowest frequency (see Table 5). From this it can be seen that the preferred candidates according to the present invention strongly increase the loss tangent, meaning they strongly increase the mobility within the bitumen phase and hence change the microstructure of the bitumen. This effect was observed independent of the bitumen type. As can be seen from Example 4.7, RheoFalt® HP-AM (Comp. 1.3) on the other hand did not have the same effect meaning it acts mainly upon dilution but not upon changing the asphaltene stacks and/or their dispersion. From FIG. 1 it can be seen that this effect was also the same for other benchmarks (cf. Comp. 1.4, 1.7, and 1.8) tested in bitumen 20/30, showing that this effect is intrinsic to the preferred candidates according to the present invention. From FIG. 1 it can also be seen that the effect was not only observed at low frequencies but even throughout the whole frequency range, meaning that it is a very pronounced effect.

TABLE 5
The following abbreviations are used: Suppl.—supplier;
*The Bitumen extracted from RAP was extracted using
trichloroethylene according to DIN EN 12697-1.

| Ex. | product | Suppl. | tan δ |
|---|---|---|---|
| 4.1 | Bitumen 20/30 | TOTAL Chimie | 18 |
| 4.2 | Hexamoll ® DINCH | BASF | 45 |
| 4.3 | N-Dodecyl pyrrolidone | | 80 |
| 4.4 | Poly(bis aminopropyl amine); | BASF | 30 |
| | m.w. 2000 g/mol | | |
| 4.5 | Lutensol ® XL60 | BASF | 43 |
| 4.6 | Polypropylenglycol bis | | 55 |
| | glycidylether; m.w. 380 g/mol | | |
| 4.7 | RheoFalt ® HP-AM | VENTRACO | 10 |
| 4.8 | Bitumen 50/70 | BP | 160 |
| 4.9 | Bitumen 50/70 (aged via | BP | 15 |
| | RTFOT & PAV) | | |
| 4.10 | Hexamoll ® DINCH | BASF | 35 |
| 4.11 | N-Dodecyl pyrrolidone | | 80 |
| 4.12 | Poly(bis aminopropyl amine); | BASF | 40 |
| | m.w. 2000 g/mol | | |
| 4.13 | Lutensol ® XL60 | BASF | 75 |
| 4.14 | Polypropylenglycol bis | | 75 |
| | glycidylether; m.w. 380 g/mol | | |
| 4.15 | Bitumen 50/70 | PCK Schwedt | 195 |
| 4.16 | Bitumen 50/70 (aged via | PCK Schwedt | 5 |
| | RTFOT & PAV) | | |
| 4.17 | Hexamoll ® DINCH | BASF | 40 |
| 4.18 | N-Dodecyl pyrrolidone | | 100 |
| 4.19 | Poly(bis aminopropyl amine); | BASF | 25 |
| | m.w. 2000 g/mol | | |
| 4.20 | Lutensol ® XL60 | BASF | 85 |
| 4.21 | Polypropylenglycol bis | | 105 |
| | glycidylether; m.w. 380 g/mol | | |
| 4.22 | Bitumen extracted from RAP* | | 15 |
| 4.23 | Hexamoll ® DINCH | BASF | 25 |
| 4.24 | N-Dodecyl pyrrolidone | | 70 |
| 4.25 | Poly(bis aminopropyl amine); | BASF | 25 |
| | m.w. 2000 g/mol | | |
| 4.26 | Lutensol ® XL60 | BASF | 45 |
| 4.27 | Polypropylenglycol bis | | 45 |
| | glycidylether; m.w. 380 g/mol | | |

### Example 5: Ageing Behavior after 3×RTFOT, Monitored Via the Loss Tangent, Tan δ

In the following it will be shown that even after ageing the positive effects of the herein claimed rejuvenating agents on the molecular mobility persist. Different bitumen types were therefore rejuvenated with some of the herein claimed rejuvenating agents according to example 4 but were subsequently aged via repeated RTFOT ageing (3 cycles of RTFOT ageing) before the frequency sweep tests. From all graphs shown below, it can be seen that the positive effect of the herein claimed rejuvenating agents on the molecular mobility of the binder persist after ageing and was also observed throughout the whole frequency range, meaning that their effect on the microstructure is a very pronounced one. All graphs also show the value for a fresh binder (50/70) for reference, and it can be nicely seen that the herein claimed rejuvenating agents are partly or sometimes even completely able to restore the properties of a fresh binder, an effect that was never observed for any of the benchmarks.

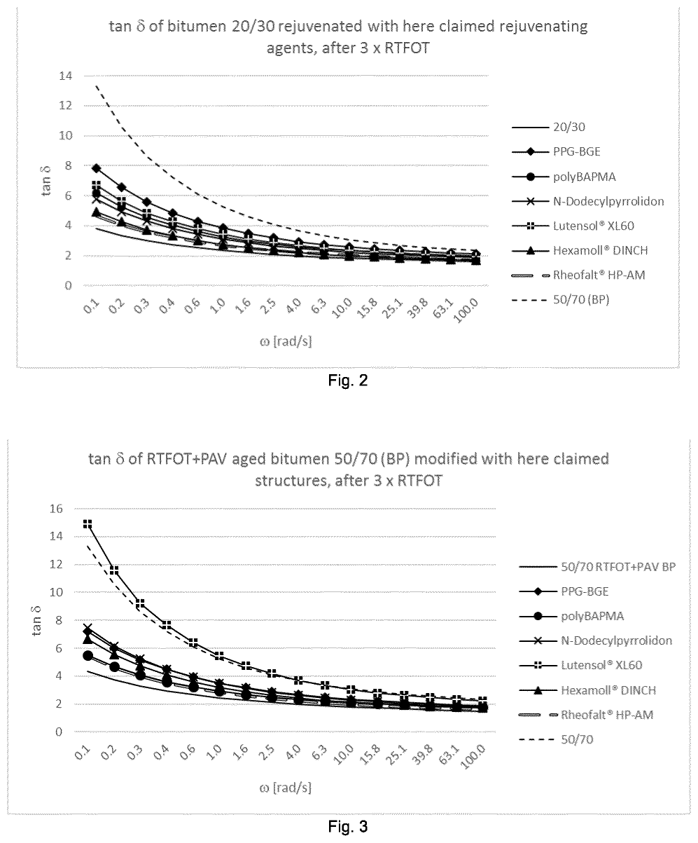

First, we tested some of the herein claimed rejuvenating agents in bitumen 20/30, a system that resembles quite well aged bitumen as detailed earlier. To be able to evaluate the effectiveness of the herein claimed rejuvenating agents (FIG. 2), we compared the results with bitumen 20/30 (purchased from TOTAL Chimie) that was rejuvenated with the benchmark Rheofalt® HP-AM (FIG. 2). It can be seen that the herein claimed rejuvenating agents reach a higher loss tangent then the benchmark throughout the whole frequency range, confirming the improved impact of the herein claimed rejuvenating agents over the state of the art, from which it is believed they only have a limited impact on the bitumen microstructure.

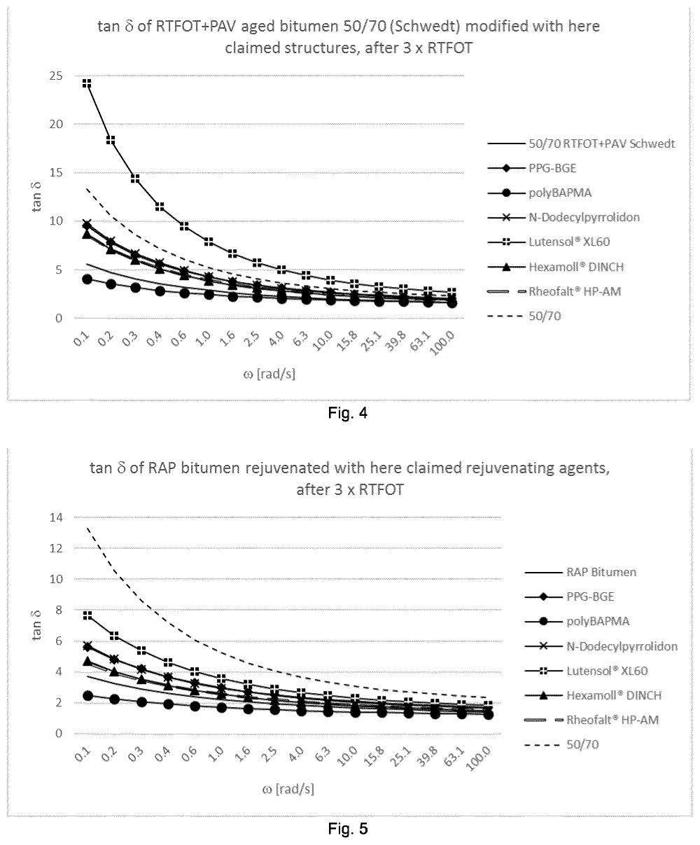

To show that this effect is independent from the binder used, the same rejuvenating agents of this invention in different types of aged bitumen were tested. Those different bitumen types were two 50/70 binders from two different refineries (BP, FIG. 3, and Schwedt, FIG. 4) that were aged via RTFOT and PAV prior to rejuvenation as well as a binder extracted from an asphalt pavement (RAP, FIG. 5) prior to rejuvenation. Again, Rheofalt® HP-AM was used as a benchmark in these tests. From the results it can be seen that the herein claimed rejuvenating agents always performed better than the benchmark, meaning that after 3×RTFOT ageing they always had a higher loss tangent then the pure bitumen as well as the bitumen rejuvenated with the benchmark. Only the rejuvenating agent polyBAPMA showed a lower loss tangent in two of the bitumen types, probably indicating that the ageing of this additive is slightly more binder dependent than it is for the other rejuvenating agents.

### Example 6: Rejuvenating Agent Performance on Polymer-Modified Bitumen (PmB)

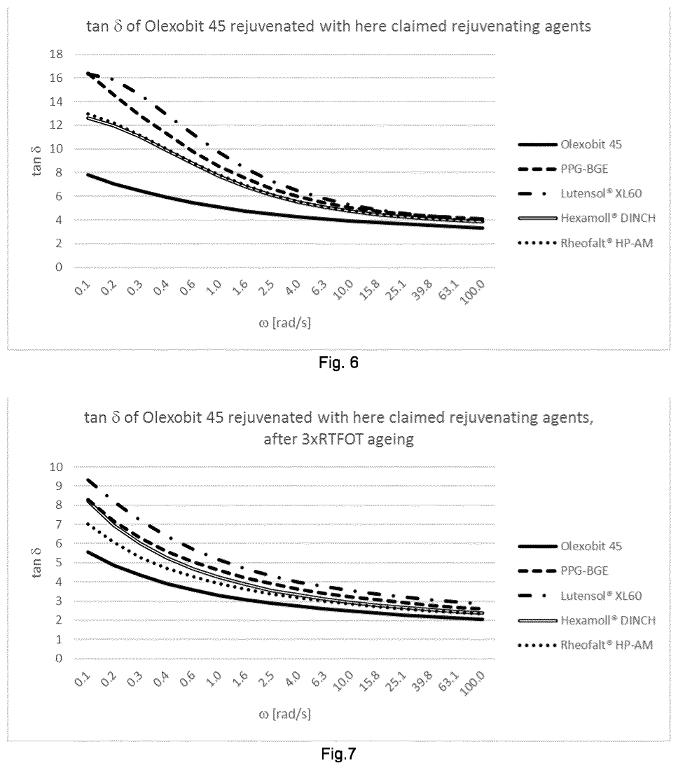

Herewith, it will be shown that the positive effects of the here claimed rejuvenating agents can also be applied to PmB, in this case Olexobit 45. Olexobit 45 was therefore rejuvenated according to the procedure of Example 1. From Table 6 it can be seen that the here claimed rejuvenating agents were able to also rejuvenate Olexobit 45 and that their effect was stronger than that for the tested benchmark. From FIG. 6 it can be seen that the molecular mobility also changes for Olexobit 45, in a similar way as it does for unmodified bitumen. This effect still persists after 3×RTFOT ageing as can be seen from FIG. 7. In addition, the ageing of Olexobit is unchanged or improved upon rejuvenation as can be seen from the ageing index (AI) in Table 6.

TABLE 6
The following abbreviations are used: SP—softening point; Rec.—recovery;
AI—ageing index

| | | | | | | | | | Force | | |
|---|---|---|---|---|---|---|---|---|---|---|---|
| | | | | MSCR % Rec. | | | BBR | | Ductility | | |
| | | | η(135° C.) | (0.1 | (1.6 | (3.2 | S-value | | W | Fₘₐₓ | |
| Ex. | Product | SP [° C.] | [mPas] | kPa) | kPa) | kPa) | [MPa] | m-value | [J/cm²] | [N] | AI |
| 6.1 | Olexobit 45 | 59.0 | 1,150 | 32 | 21 | 15 | 200 | 0.31 | 5.2 | 68 | 2.1 |
| 6.2 | Hexamoll ® | 49.0 | 700 | 19 | 7 | 4 | 80 | 0.43 | 1.0 | 12 | 2.1 |
| | DINCH | | | | | | | | | | |
| 6.3 | Lutensol ® | 46.5 | 600 | 12 | 2 | 0 | 75 | 0.45 | 0.8 | 10 | 1.8 |
| | XL 60 | | | | | | | | | | |
| 6.4 | Polypropylen- | 48.0 | 650 | 15 | 4 | 1 | 120 | 0.39 | 1.1 | 14 | 2.2 |
| | glycol | | | | | | | | | | |
| | bis | | | | | | | | | | |
| | glycidylether; | | | | | | | | | | |
| | m.w. | | | | | | | | | | |
| | 380 g/mol | | | | | | | | | | |
| 6.5 | RheoFalt ® | 52.0 | 700 | 19 | 8 | 5 | 140 | 0.37 | 1.8 | 23 | 2.0 |
| | HP-AM | | | | | | | | | | |

### Example 7: Rejuvenating Agent Performance Evaluated by TD NMR Relaxation Time Measurements

To show that the impact on the bitumen microstructure observed for the herein claimed rejuvenating agents is not solely an effect of the DSR frequency sweep that was used in examples 4 and 5, the effect on the microstructure was additionally probed using a physicochemical analysis of the bitumen samples, in this specific case using time-domain NMR (TD NMR).

TD NMR, also known as NMR relaxometry, is a known NMR technique and relies on measuring the relaxation times of the nuclear spin system instead of frequency-domain spectra. Recording these parameters can be achieved with much lower and less homogeneous magnetic fields and thus TD NMR spectrometers are relatively compact and rugged instruments with permanent magnets that do not require cooling. Also, sample preparation is much simpler as there are no concerns about sample homogeneity and no solvents are needed.

The TD NMR is very well suited for the purpose of evaluating effects on the bituminous microstructure, as protons in chemical environments with different local molecular mobilities exhibit different and characteristic relaxation times. Like that, a clear distinction between protons in a solid, amorphous and liquid component can be made with good accuracy. Hence, should a rejuvenating agent impact the microstructure of the bitumen, it will lower the amount of the solid component and increase the amount of the liquid component(s). Also, the more effective the rejuvenating agent, the higher will be the mobility of the liquid component(s).

Bitumen 20/30 was rejuvenated with some of the here claimed rejuvenating agents according to example 1. The pure bitumen 20/30 as well as the rejuvenated bitumen 20/30 samples were then analyzed by TD NMR. To do so, all samples were heated up to 80° C. to allow filling of the samples into NMR tubes. After that, TD NMR measurements at 30° C., 80° C. and 140° C. were conducted using the SE-CMPG sequence. This sequence consists of a solid echo combined with a so-called CPMG (Carr-Purcell-Meiboom-Gill) train of subsequent spin echoes with alternating phase and is capable of recording the decay of coherence in the transverse nuclear magnetization over about 5 orders of magnitude in time. Depending on the measurement temperature, the experimental data were then fitted with semi-empirically selected multicomponent models involving several Gaussian and exponential components:

S(t)=[p_{g1} exp(−(t/T_{2g1})²)+p_{g2} exp(−(t/T_{2g2})²)]+pₑ₁ exp(−t/T₂ₑ₁)[pₑ₂ exp(−t/T₂ₑ₂)+pₑ₃ exp(−t/T₂ₑ₃)]

In order to assess the effect of temperature on the molecular mobility of the bitumen, experiments were conducted at temperatures of 30° C., 80° C. and 140° C., and the following models turned out to provide adequate fits of the respective normalized signal decay curves:
two Gaussians and one exponential at 30° C.,
two Gaussians and two exponentials at 80° C.,
three exponentials at 140° C.

From the fitting, different values can be obtained:
The p values (pg1, pg2, pe1, pe2 and pe3), indicating the signal fraction of the individual component scaled in the range from 0 to 1
The T2 values (T2g1, T2g2, T2e1, T2e2 and T2e3), indicating the relaxation times that correspond to each of the individual components. The longer the relaxation time, the higher the molecular mobility of the respective component
In addition to the values T2e1, T2e2 and T2e3, we also calculated the average relaxation time of the mobile components, 1/<1/T2e>, for the temperatures at which more than one mobile component exist (80 and 140° C.). 1/<1/T2e> Is calculated as the harmonic average of the relaxation times involved:

$$\frac{1}{〈 1 / {T}_{2 e} 〉} = \frac{{p}_{e 1} + {p}_{e 2} + {p}_{e 3}}{{p}_{e 1} / {T}_{2 e 1} + {p}_{e 2} / {T}_{2 e 2} + {p}_{e 3} / {T}_{2 e 3}}$$

The type of the component, those being:
   g1: the rigid component
   g2: the partially mobile component
   e1, e2 and e3: mobile components with increasingly high local molecular mobilities

It is believed that the rigid component g1 is directly correlated with the amount of the asphaltene aggregates. The mobile component(s) on the other hand can be attributed to the maltene phase. Both the p value (the amount of the individual component) and the T2 values (the relaxation time and hence the mobility of the component) are important values to be considered for the interpretation of the TD NMR data.

In general, it was found that all rejuvenating agents (including the benchmark) lead to shifts towards longer relaxation times (and thus higher molecular mobility) at all temperatures studied. All rejuvenating agents lowered the solid content pg1 at 30 and 80° C., at 140° C. no solid content exists anymore, not even in the unrejuvenated sample. The manifestation of the different effectiveness of the rejuvenating agents was found to decrease relatively with increasing temperature. This is however due to the temperature-dependent melting of the bitumen at higher temperatures being the dominant effect, rather than the rejuvenating agent being less effective at higher temperatures. As a constant trend it was found that the herein claimed rejuvenating agents performed on average better than the benchmark. The individual ranking of shifts amongst the herein claimed rejuvenating agents are different at different temperatures, but it can be said that Lutensol® XL60 and N-Dodecylpyrrolidone had the biggest impact on the mobility of the bitumen phase. The detailed results for the individual temperatures will be described below.

30° C.:

At 30° C. it was found that the signal fraction of the rigid solid component pg1 is reduced for all rejuvenated samples. Amongst the tested samples, the benchmark had the lowest impact on pg1, showing that the herein claimed rejuvenating agents have a bigger impact. The relaxation time T2g1 of the solid component pg1 is nearly similar for all samples, meaning that even though in quantity they diminished, the type of structure did not change. Similarly, all rejuvenating agents increased the amount of the mobile component pe1 as well as its mobility T2e1, with the herein claimed rejuvenating agents having the biggest effect. The impact on the weakly mobile Gaussian pg2 is less pronounced but follows a similar trend.

TABLE 7
Multicomponent fitting results at 30° C.

| Ex. | Sample | pg1 | T2g1 [ms] | pg2 | T2g2 [ms] | pe1 | T2e1 [ms] |
|---|---|---|---|---|---|---|---|
| 7.1 | Bitumen 20/30 | 0.45 | 0.016 | 0.16 | 0.038 | 0.38 | 0.13 |
| 7.2 | 20/30 + Palatinol ® N | 0.40 | 0.016 | 0.17 | 0.046 | 0.42 | 0.21 |
| 7.3 | 20/30 + PPG-BGE MW | 0.40 | 0.016 | 0.18 | 0.044 | 0.41 | 0.20 |
| | 380 | | | | | | |
| 7.4 | 20/30 + PolyBAPMA | 0.410 | 0.016 | 0.17 | 0.044 | 0.40 | 0.17 |
| 7.5 | 20/30 + N-Dodecyl | 0.38 | 0.016 | 0.17 | 0.045 | 0.44 | 0.20 |
| | pyrrolidone | | | | | | |
| 7.6 | 20/30 + Lutensol ® XL 60 | 0.39 | 0.016 | 0.18 | 0.045 | 0.42 | 0.23 |
| 7.7 | 20/30 + Rheofalt ® HP-AM | 0.42 | 0.016 | 0.17 | 0.044 | 0.39 | 0.18 |

80° C.:

At 80° C. the signal fraction of the rigid solid component pg1 is drastically reduced compared to 30° C., due to the melting of the bitumen. For all rejuvenated samples it is also strongly reduced compared to the unrejuvenated bitumen 20/30. Again, all the herein claimed rejuvenating agents reduce pg1 more than Rheofalt® HP-AM. As for 30° C., the relaxation time T2g1 of the solid component pg1 is similar for all samples. More pronounced differences for the relaxation times of the exponential components than for the weakly mobile Gaussian pg2 were noticed. From the relaxation times T2e1 and T2e2 and from 1/<l/T2e> it can be seen that Rheofalt® HP-AM has the smallest effect on the mobility of the mobile component.

TABLE 8
Multicomponent fitting results at 80° C.

| | | | T2g1 | | T2g2 | | T2e1 | | T2e2 | 1/<1/T2e> |
|---|---|---|---|---|---|---|---|---|---|---|
| Ex. | Sample | pg1 | [ms] | pg2 | [ms] | pe1 | [ms] | pe2 | [ms] | [ms] |
| 7.8 | Bitumen | 0.12 | 0.017 | 0.078 | 0.052 | 0.43 | 0.33 | 0.36 | 1.71 | 0.52 |
| | 20/30 | | | | | | | | | |
| 7.9 | 20/30 + | 0.10 | 0.017 | 0.074 | 0.050 | 0.44 | 0.43 | 0.38 | 2.23 | 0.69 |
| | Palatinol ® | | | | | | | | | |
| | N | | | | | | | | | |
| 7.10 | 20/30 + | 0.10 | 0.017 | 0.078 | 0.053 | 0.46 | 0.47 | 0.35 | 2.42 | 0.72 |
| | PPG-BGE | | | | | | | | | |
| | MW 380 | | | | | | | | | |
| 7.11 | 20/30 + | 0.10 | 0.018 | 0.072 | 0.056 | 0.45 | 0.45 | 0.37 | 2.22 | 0.70 |
| | PolyBAPMA | | | | | | | | | |
| 7.12 | 20/30 + | 0.09 | 0.017 | 0.074 | 0.054 | 0.48 | 0.50 | 0.35 | 2.53 | 0.76 |
| | N-Dodecyl | | | | | | | | | |
| | pyrrolidone | | | | | | | | | |
| 7.13 | 20/30 + | 0.10 | 0.017 | 0.068 | 0.054 | 0.44 | 0.45 | 0.39 | 2.41 | 0.72 |
| | Lutensol ® | | | | | | | | | |
| | XL 60 | | | | | | | | | |
| 7.14 | 20/30 + | 0.11 | 0.017 | 0.077 | 0.053 | 0.46 | 0.42 | 0.35 | 2.20 | 0.65 |
| | Rheofalt ® | | | | | | | | | |
| | HP-AM | | | | | | | | | |

140° C.:

At 140° C., no more rigid solid component pg1 exists for any of the samples, meaning all samples are liquid. At this temperature, the differences in component patterns are less pronounced than for lower temperatures, due to the bitumen already being liquid when unrejuvenated. However, it can clearly be seen, that the herein claimed rejuvenating agents have higher signal fractions of the components with the higher mobility (pe2 and pe3), whereas the benchmark has the highest signal fraction of the component with the lowest mobility (pe1). The relaxation times of all components are systematically longer for samples with added rejuvenating agents. From the average relaxation time 1/<1/T2e> it can be seen that Rheofalt® HP-AM has one of the shortest, meaning it leads to the lowest mobility amongst all rejuvenated samples.

TABLE 9
Multicomponent fitting results at 140° C.

| | | | | | | | | 1/<1/T2e> |
|---|---|---|---|---|---|---|---|---|
| Ex. | Sample | pe1 | T2e1 [ms] | pe2 | T2e2 [ms] | pe3 | T2e3 [ms] | [ms] |
| 7.15 | Bitumen | 0.18 | 0.15 | 0.48 | 3.37 | 0.32 | 19.27 | 0.73 |
| | 20/30 | | | | | | | |
| 7.16 | 20/30 + | 0.18 | 0.18 | 0.45 | 4.09 | 0.35 | 22.87 | 0.87 |
| | Palatinol ® N | | | | | | | |
| 7.17 | 20/30 + | 0.18 | 0.20 | 0.47 | 4.45 | 0.34 | 24.51 | 0.94 |
| | PPG-BGE | | | | | | | |
| | MW 380 | | | | | | | |
| 7.18 | 20/30 + | 0.18 | 0.20 | 0.46 | 4.56 | 0.34 | 24.22 | 0.98 |
| | PolyBAPMA | | | | | | | |
| 7.19 | 20/30 + N- | 0.18 | 0.21 | 0.47 | 4.76 | 0.34 | 25.72 | 1.0 |
| | Dodecyl | | | | | | | |
| | pyrrolidone | | | | | | | |
| 7.20 | 20/30 + | 0.18 | 0.19 | 0.45 | 4.33 | 0.35 | 24.76 | 0.91 |
| | Lutensol ® XL | | | | | | | |
| | 60 | | | | | | | |
| 7.21 | 20/30 + | 0.19 | 0.19 | 0.47 | 4.26 | 0.33 | 23.51 | 0.89 |
| | Rheofalt ® | | | | | | | |
| | HP-AM | | | | | | | |

1.-14. (canceled)

15. A binder composition comprising
(a) a bituminous binder; and
(b) a rejuvenating agent from 0.05 to 20 wt.-%, based on the total amount of the binder composition,
wherein the rejuvenating agent comprises at least an asphaltene dispersant, which is selected from the group consisting of alkoxylates, N,N-dialkylamides of aliphatic carboxylic acids, N-alkyl lactames, and poly(alkylamines),
an asphaltene reactivator, which is selected from the group consisting of mono glycidylether and glycidylester, di- and tri glycidylether, diglycidylether of polymeric alcohol, and mixtures thereof with catalysts,
a maltene reactivator, which is a plasticizer,
or mixtures thereof.

16. The binder composition according to claim 15, wherein the rejuvenating agent introduces a microstructural change of the bitumen micellar structure, wherein the loss tangent of the binder composition is increased compared to the loss tangent of the bituminous binder and/or
wherein the amount of the mobile components of the binder composition and/or their respective mobility as per TD NMR is increased compared to the amount of the mobile components of the bituminous binder and/or their respective mobility.

17. The binder composition according to claim 15,
wherein the rejuvenating agent comprises
(i) the asphaltene dispersant from 1 to 100 wt. %, based on the total amount of the rejuvenating agent;
(ii) the asphaltene reactivator from 1 to 100 wt. %, based on the total amount of the rejuvenating agent;
(iii) the maltene reactivator from 1 to 100 wt. %, based on the total amount of the rejuvenating agent; or
(iv) a mixture consisting of at least two of the components from (i) to (iii) from 1 to 100 wt. %, based on the total amount of the rejuvenating agent.

18. The binder composition according to claim 15, wherein the bituminous binder comprises reclaimed asphalt pavement binder, reclaimed asphalt shingle binder, virgin bitumen with a hardness grade of at least 50/70, or a mixture thereof, optionally in combination with a virgin binder.

19. The binder composition according to claim 15, wherein the binder composition comprises
an asphaltene dispersant selected from the group consisting of alkoxylates having the structure of formula (1) 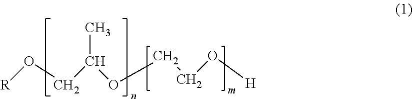
wherein
R is H, C₁-C₂₂-alkyl, C₂-C₂₂-alkenyl, phenyl, or alkyl phenyl,
n is 0 to 20,
m is 0 to 20, and wherein
n+m≥1;
N,N-dialkylamides of aliphatic carboxylic acids having the structure of formula (2) 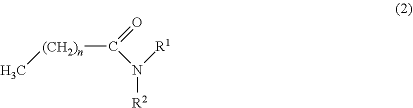
wherein
n is 3 to 16, wherein the carbon atom of at least one “CH₂” moiety may be further substituted with at least one C₁-C₅-alkyl and wherein at least two carbon atoms of two adjacent “CH₂” moieties may form a double bond,
R¹ is C₁-C₄-alkyl, and
R² is C₁-C₄-alkyl;
N-alkyl lactames having the structure of formula (3) 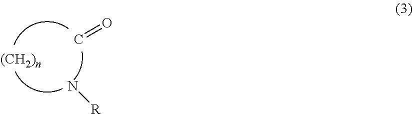
wherein
n is 3 to 11, wherein the carbon atom of at least one “CH₂” moiety may be further substituted with at least one C₁-C₃-alkyl, and
R is C₁-C₂₂-alkyl or C₂-C₂₂-alkenyl; or
poly(alkylamines) having the structure of formula (4) 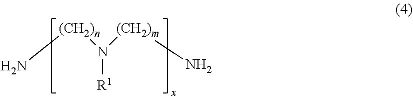
wherein
n is 1 to 6, wherein at least two carbon atoms of two adjacent “CH₂” moieties may form a double bond,
m is 1 to 6, wherein at least two carbon atoms of two adjacent “CH₂” moieties may form a double bond,
x is 4 to 50, and
R¹ is C₁-C₄-alkyl,
wherein these poly(alkylamines) may further be derived at the terminal amine moieties with C₁-C₄-alkyl, fatty acids or alkoxylated;
and/or an asphaltene reactivator, which is selected from the group consisting of mono glycidylether and -ester, di- and tri glycidylether, diglycidylether of polymeric alcohol, and mixtures thereof with catalysts such as N,N-dimethyl benzylamine, wherein the mono glycidylether and -ester, di- and tri glycidylether, diglycidylether of polymeric alcohol have the structure of formula (5a), (5b), (5c), and 5(d) 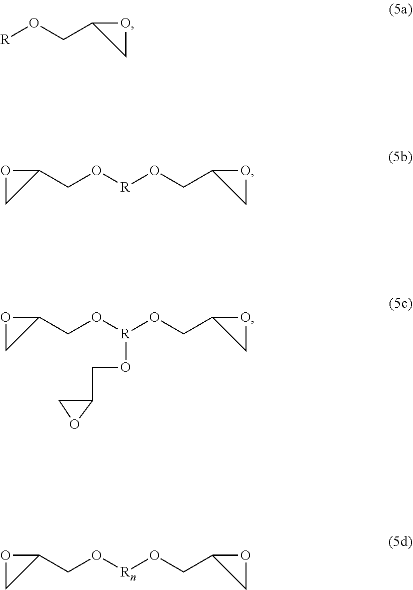
wherein
for formula (5a)
R is C₁-C₂₀-alkoxy, C₂-C₂₀-alkenyloxy, phenoxy, or C₁-C₂₀-carboxyalkyl, wherein the phenoxy may be further substituted with at least one C₁-C₁₅-alkyl;
for formula (5b)
R is straight C₅-C₂₀-alkylene which may be further substituted with at least one C₁-C₅-alkyl or C₁-C₄-alkylene, which is further substituted with at least one C₁-C₁₀-alkyl and/or at least one phenyl;
for formula (5c)
R is C₁-C₅-alkylene; and
for formula (5d)
Rₙ has the formulae (6a), (6b), or (6c)
(—CH₂CH₂O—)ₙ (6a),
wherein n is 3 to 20,
(—CH₂CH(CH₃)O—)ₙ (6b),
wherein n is 3 to 18, or
(—CH₂CH₂CH₂CH₂O—)ₙ (6c)
wherein n is 3 to 18;
and/or a maltene reactivator, which is a plasticizer having the formula (7a), (7b), (7c), (7d), or (7e), 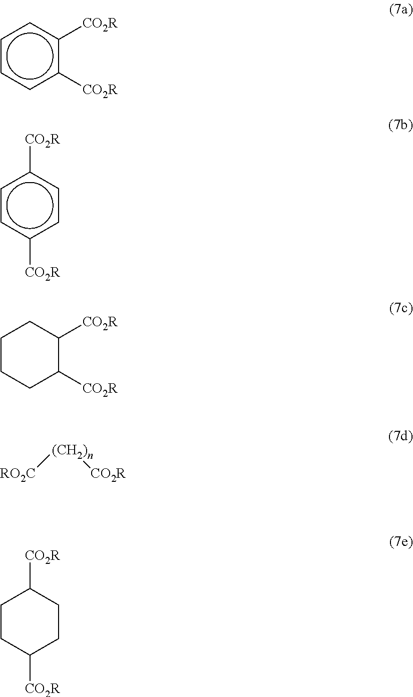
wherein
for formula (7a)
R is C₄-C₁₄-alkyl or C₄-C₁₄-alkenyl;
for formula (7b)
R is C₄-C₁₄-alkyl or C₄-C₁₄-alkenyl;
for formula (7c)
R is C₄-C₁₄-alkyl or C₄-C₁₄-alkenyl;
for formula (7d)
R is C₄-C₁₄-alkyl or C₄-C₁₄-alkenyl;
for formula (7e)
R is C₄-C₁₄-alkyl or C₄-C₁₄-alkenyl, and
n is 4 to 10, wherein at least two carbon atoms of two adjacent “CH₂” moieties may form a double bond.

20. The binder composition according to claim 15, wherein the asphaltene dispersant is present and is selected from the group consisting of alkoxylates having the structure of formula (1) 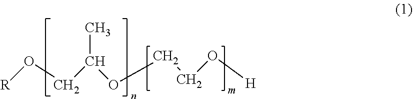
wherein
R is H, C₁-C₂₂-alkyl, C₂-C₂₂-alkenyl, phenyl, or alkyl phenyl,
n is 0 to 20,
m is 0 to 20, and wherein
n+m ≥1;
in particular wherein the alkoxylates have the structure of formula (1), wherein
R is C₁₀-alkyl or C13-alkyl,
n is 0 to 6,
m is 0 to 8, and wherein
n+m ≥5;
N,N-dialkylamides of aliphatic carboxylic acids having the structure of formula (2) 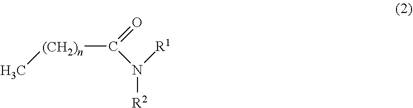
wherein
n is 3 to 16, wherein the carbon atom of at least one “CH₂” moiety may be further substituted with at least one C₁-C₅-alkyl and wherein at least two carbon atoms of two adjacent “CH₂” moieties may form a double bond, wherein the carbon atom of at least one “CH₂” moiety may be further substituted with at least one C₁-C₅-alkyl,
R¹ is C₁-C₄-alkyl, and
R² is C₁-C₄-alkyl;
in particular wherein the N,N-dialkylamides of aliphatic carboxylic acids have the structure of formula (2), wherein
n is 8 to 12,
R¹ is methyl or ethyl, and
R² is methyl or ethyl;
N-alkyl lactames having the structure of formula (3) 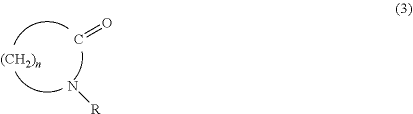
wherein
n is 3 to 11, wherein the carbon atom of at least one “CH₂” moiety may be further substituted with at least one C₁-C₃-alkyl, preferably 3 (pyrrolidone), 5 (caprolactam), or 11 (laurolactam), and
R is C₁-C₂₂-alkyl or C₂-C₂₂-alkenyl, preferably C₄-C₁₈-alkyl;
in particular wherein the N-alkyl lactames have the structure of formula (3), wherein
n is 3 (pyrrolidone), and
R is C₅-C₁₂-alkyl; or
poly(alkylamines) having the structure of formula (4) 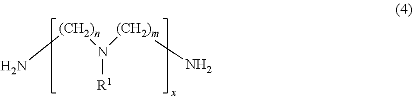
wherein
n is 1 to 6, preferably 2 to 3, wherein at least two carbon atoms of two adjacent “CH₂” moieties may form a double bond,
m is 1 to 6, preferably 2 to 3, wherein at least two carbon atoms of two adjacent “CH₂” moieties may form a double bond,
x is 4 to 50, and
R¹ is C₁-C₄-alkyl,
wherein these poly(alkylamines) may further be derived at the terminal amine moieties with C₁-C₄-alkyl, fatty acids or alkoxylated;
in particular wherein the poly(alkylamine) is selected from the group consisting of oligo-N,N-bis-(3-aminopropyl) methylamin and poly-N,N-bis-(3-aminopropyl) methylamin.

21. The binder composition according to claim 15, wherein the asphaltene reactivator is present and is selected from the group consisting of mono glycidylether and -ester, di- and tri glycidylether, diglycidylethers of polymeric alcohol, and mixtures thereof with catalysts; wherein the mono glycidylether and -ester, di- and tri glycidylether, diglycidylethers of polymeric alcohol have the structure of formula (5a), (5b), (5c), and 5(d) 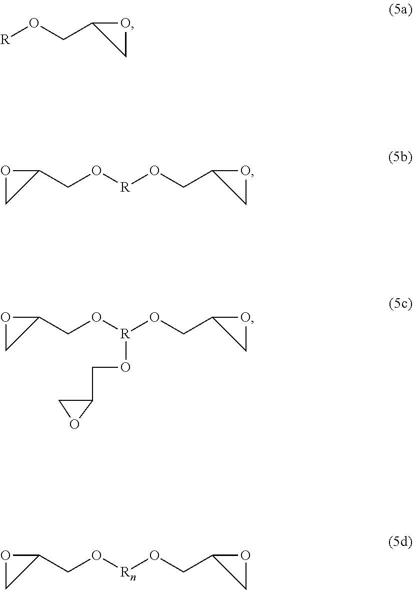
wherein
for formula (5a)
R is C₁-C₂₀-alkoxy, C₂-C₂₀-alkenyloxy, phenoxy, or C₁-C₂₀-carboxyalkyl, wherein the phenoxy may be further substituted with at least one C₁-C₁₅-alkyl, preferably C₄-C₁₆-alkoxy, preferably 2-ethylhexanolate, n-butanolate, tert.-butanolate, C₁₂-C₁₅-alkoxy, nonylphenolate, allyl alcoholate, or neodecanoic carboxylate;
for formula (5b)
R is straight C₅-C₂₀-alkylene which may be further substituted with at least one C₁-C₅-alkyl or C₁-C₄-alkylene, which is further substituted with at least one C₁-C₁₀-alkyl and/or at least one phenyl, preferably straight C₅-Cis-alkylene which may be further substituted with at least one C₁-C₄-alkyl or a C₁-C₃-alkylene, which is further substituted with at least one C₁-C₅-alkyl and/or at least one phenyl;
for formula (5c)
R is C₁-C₅-alkylene; and
for formula (5d)
Rₙ has the formulae (6a), (6b), or (6c)
(—CH₂CH₂O—)ₙ (6a),
wherein n is 3 to 20,
(—CH₂CH(CH₃)O—)ₙ (6b),
wherein n is 3 to 18, or
(—CH₂CH₂CH₂CH₂O—)ₙ (6c)
wherein n is 3 to 18;
wherein the asphaltene reactivator is selected from the group consisting of polyethyleneglycol bis(glycidyl)ether, polypropyleneglycol bis(glycidyl)ether, neopentylglycol bis glycidylether, 2-methyl-2-phenyl-1,3-propandiol bis glycidylether, 2-ethylhexyl glycidyl ether, and mixtures of these compounds with catalysts.

22. The binder composition according to claim 15, wherein the maltene reactivator is present and is a plasticizer having the formula (7a), (7b), (7c), (7d), or (7e), 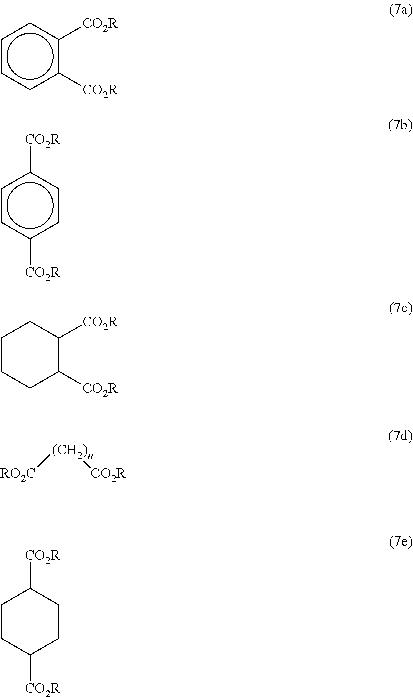
wherein
for formula (7a)
R is C₄-C₁₄-alkyl or C₄-C₁₄-alkenyl;
for formula (7b)
R is C₄-C₁₄-alkyl or C₄-C₁₄-alkenyl;
for formula (7c)
R is C₄-C₁₄-alkyl or C₄-C₁₄-alkenyl;
for formula (7d)
R is C₄-C₁₄-alkyl or C₄-C₁₄-alkenyl;
for formula (7e)
R is C₄-C₁₄-alkyl or C₄-C₁₄-alkenyl, and
n is 4 to 10, wherein at least two carbon atoms of two adjacent “CH₂” moieties may form a double bond,
wherein the plasticizer has the formula (7a), (7c), or (d), wherein
for formula (7a)
R is C₅-C₁₂-alkyl or C₇-C₁₂-alkenyl;
for formula (7c)
R is C₅-C₁₂-alkyl or C₇-C₁₂-alkenyl;
for formula (7d)
R is C₅-C₁₂-alkyl or C₇-C₁₂-alkenyl, preferably C₅-C₁₁-alkyl, and
n is 4 to 8, wherein at least two carbon atoms of two adjacent “CH₂” moieties may form a double bond.

23. The binder composition according to claim 15, wherein the bituminous binder comprises reclaimed asphalt pavement and/or reclaimed asphalt shingles binder from 10 to 100 wt.-%, based on the total weight of the bituminous binder.

24. The binder composition according to claim 15, wherein the bituminous binder comprises further additives selected from the group consisting of polymers, waxes, fibers, and mixtures thereof.

25. An asphalt composition comprising aggregate and the binder composition according to claim 15.

26. A paved road surface, road subsurface, runway, driveway, parking lot, road shoulder, bridge, bridge abutment, roofing, bank revetment, or unpaved road comprising the asphalt composition according to claim 25.

27. A method for evaluating the efficiency of a rejuvenating agent in a binder composition, wherein the efficiency of the rejuvenating agent is proven via
(i) the loss tangent before or after ageing, obtained from a dynamic shear rheometer (DSR) frequency sweep at a defined temperature, wherein the frequency sweep is measured at a temperature from 0 to 90° C. and wherein an effective rejuvenating agent fulfills inequation (a)
loss tangent[bc]>1.3×loss tangent [bb], (a)
wherein loss tangent[bc] denotes the loss tangent of the binder composition and loss tangent [bb] denotes the bituminous binder and wherein loss tangent[bc] and loss tangent [bb] are evaluated at a frequency from 0.01 to 10 rad/s, or
(ii) TD NMR relaxation experiments performed on bitumen samples at a temperature of from −50 to 200° C. and wherein an effective rejuvenating agent fulfills inequation (aa1)
T2e1[bc]>1.3×T2e1[bb] (aa1)
wherein T2e1[bc] denotes the relaxation times that correspond to the individual component of the binder composition and T2e1[bb] denotes the relaxation times that correspond to the individual component of the bituminous binder.

28. A method comprising utilizing an rejuvenating agent comprising at least an asphaltene dispersant, selected from the group consisting of alkoxylates, N,N-dialkylamides of aliphatic carboxylic acids, N-alkyl lactames, and poly(alkylamines), an asphaltene reactivator selected from the group consisting of mono glycidylether and -ester, di- and tri glycidylether, diglycidylether of polymeric alcohol, and mixtures thereof with catalysts, a maltene reactivator, which is a plasticizer, or mixtures thereof for recycling Reclaimed Asphalt Pavement (RAP) and/or asphalt shingles from roofing (RAS).
